(19) United States
(12) Patent Application Publication
(10) Pub. No.: US 2025/0030778 A1
(43) Pub. Date: Jan. 23, 2025

(54) METHOD AND APPARATUS FOR RECOMMENDING MEDIA SHARING ROOM, ELECTRONIC DEVICE, STORAGE MEDIUM, AND PROGRAM PRODUCT

(71) Applicant: TENCENT TECHNOLOGY (SHENZHEN) COMPANY LIMITED, Shenzhen (CN)

(72) Inventors: Jianping SHI, Shenzhen (CN); Xiaonan LIU, Shenzhen (CN); Songsong JIA, Shenzhen (CN); Ermei CAO, Shenzhen (CN)

(21) Appl. No.: 18/904,176

(22) Filed: Oct. 2, 2024

Related U.S. Application Data
(63) Continuation of application No. PCT/CN2023/088324, filed on Apr. 14, 2023.

(30) Foreign Application Priority Data
Nov. 30, 2022 (CN) 202211528328.1

(51) Int. Cl. H04L 67/52; H04L 9/00

(52) U.S. Cl. CPC H04L 67/52; H04L 9/008

(57) ABSTRACT

This application provides a method and apparatus for recommending a media sharing room, an electronic device, a computer-readable storage medium, and a computer program product. The method includes determining, in response to a request to join a media sharing room by a target object, a recommended area associated with a to-be-recommended media sharing room; generating a first Bloom filter array corresponding to a location of the recommended area, and transmitting the first Bloom filter array to a terminal of the target object; receiving, from the terminal, a result indicating whether the target object is located in the recommended area, the result being determined based on the first Bloom filter array and a second Bloom filter array, and the second Bloom filter array corresponding to a location of the target object; and recommending the media sharing room when the result indicates that the target object is located in the recommended area.

### RELATED APPLICATIONS

This application is a continuation of PCT Application No. PCT/CN2023/088324 filed on Apr. 14, 2023, which in turn claims priority to Chinese Patent Application No. 2022115283281 filed on Nov. 30, 2022, which are incorporated herein by reference in their entirety.

### FIELD OF THE TECHNOLOGY

This application relates to the field of internet technologies, and in particular, to a method and apparatus for recommending a media sharing room, an electronic device, a computer-readable storage medium, and a computer program product.

### BACKGROUND OF THE DISCLOSURE

With the development of the internet, more users view media content (such as videos) through a network. A media sharing room allows users who join the media sharing room to view the media content together. To attract users to join the media sharing room, the media sharing room may be recommended to users near the creator of the media sharing room. In the related art, the recommendation is implemented through a location based service (LBS). A server obtains real locations of users, and then recommends, according to distances between the real location of the creator and the real locations of the users, the media sharing room to the users who are distant from the creator by less than a distance threshold. However, in the related art, because the server needs to obtain the real locations of the users, there is a risk of compromising location privacy of the users, leading to potential security issues.

### SUMMARY

Embodiments of this application provide a method and apparatus for recommending a media sharing room, an electronic device, a computer-readable storage medium, and a computer program product, to improve security of location privacy when a recommendation of the media sharing room is made based on a location.

Technical solutions in embodiments of this application are implemented as follows:

An embodiment of this application provides a method for recommending a media sharing room. The method is performed by an electronic device, including determining, in response to a request to join a media sharing room by a target object, a recommended area associated with a to-be-recommended media sharing room, a distance between the recommended area and a creator of the media sharing room being less than a distance threshold, and the media sharing room being configured for at least one viewer who joins the media sharing room to view media content played in the media sharing room; generating a first Bloom filter array corresponding to a location of the recommended area, and transmitting the first Bloom filter array to a terminal of the target object; receiving, from the terminal, a result indicating whether the target object is located in the recommended area, the result being determined based on the first Bloom filter array and a second Bloom filter array, and the second Bloom filter array corresponding to a location of the target object; and recommending the media sharing room to the terminal when the result indicates that the target object is located in the recommended area.

An embodiment of this application further provides an electronic device, including a memory, configured to store computer-executable instructions; and a processor, configured to implement, when executing the computer-executable instructions stored in the memory, the method for recommending a media sharing room provided in this embodiment of this application.

An embodiment of this application further provides a non-transitory computer-readable storage medium, having computer-executable instructions stored therein. When the computer-executable instructions are executed by a processor, the method for recommending a media sharing room provided in this embodiment of this application is implemented.

In embodiments of this application, after receiving a request to join a media sharing room from the target object, the recommended area associated with the to-be-recommended media sharing room is determined, the first Bloom filter array corresponding to the location of the recommended area is generated, and the first Bloom filter array is transmitted to the terminal of the target object, so that the terminal of the target object determines, based on the first Bloom filter array and the second Bloom filter array, the result indicating whether the target object is located in the recommended area, and returns the result. When the result indicating that the target object is located in the recommended area is received, the media sharing room is recommended to the terminal.

In embodiments of this application, the distance between the recommended area and the creator of the media sharing room is less than the distance threshold. When whether the target object is located in the recommended area is determined, the first Bloom filter array corresponding to the location of the recommended area is transmitted to the terminal of the target object; and the result indicating whether the target object is located in the recommended area is returned by the terminal of the target object. Accordingly, in a process of recommending the media sharing room, the target object does not need to provide a real location of the target object to another party, and a real location of the recommended area whose distance from the creator is lower than the distance threshold also does not need to be provided to the target object. This ensures that location privacy of two parties is not disclosed, and improves security of the location privacy while the recommendation of the media sharing room is made based on the location.

### BRIEF DESCRIPTION OF THE DRAWINGS

FIG. 1 is a schematic diagram of an architecture of a recommendation system 100 of a media sharing room according to an embodiment of this application.

FIG. 2 is a schematic flowchart of a method for recommending a media sharing room according to an embodiment of this application.

FIG. 3A is a schematic diagram of recommendation of a media sharing room according to an embodiment of this application.

FIG. 3B is a schematic diagram of recommendation of a media sharing room according to the related art.

FIG. 3C is a schematic diagram of recommendation of a media sharing room according to the related art.

FIG. 3D is a schematic diagram of recommendation of a media sharing room according to an embodiment of this application.

FIG. 4 is a schematic diagram of generation of a Bloom filter array according to an embodiment of this application.

FIG. 5 is a schematic diagram of recommendation of a media sharing room according to an embodiment of this application.

FIG. 6 is a schematic diagram of a recommended area according to an embodiment of this application.

FIG. 7 is a schematic diagram of a recommended area according to an embodiment of this application.

FIG. 8 is a schematic diagram of generation of a spatial Bloom filter array according to an embodiment of this application.

FIG. 9 is a schematic diagram of area division according to an embodiment of this application.

FIG. 10 is a schematic diagram of a recommended area according to an embodiment of this application.

FIG. 11A is a schematic diagram of recommendation of a media sharing room according to an embodiment of this application.

FIG. 11B is a schematic diagram of recommendation of a media sharing room according to an embodiment of this application.

FIG. 12 is a schematic flowchart of a method for recommending a media sharing room according to an embodiment of this application.

FIG. 13 is a schematic diagram of the creation of a media sharing room according to an embodiment of this application.

FIG. 14 is a live stream setting interface of a media sharing room according to an embodiment of this application.

FIG. 15A is a schematic diagram of an architecture of a recommendation system of a media sharing room according to an embodiment of this application.

FIG. 15B is a schematic diagram of an architecture of a recommendation system of a media sharing room according to an embodiment of this application.

FIG. 16 is a schematic diagram of a creation procedure and a dismissing procedure of a media sharing room according to an embodiment of this application.

FIG. 17 is a schematic diagram of an opening procedure of a media sharing room recommendation interface according to an embodiment of this application.

FIG. 18 is a schematic diagram of a processing procedure when a media sharing room recommendation interface is opened and exited according to an embodiment of this application.

FIG. 19 is a schematic diagram of a recommendation display of a media sharing room according to an embodiment of this application.

FIG. 20 is a schematic diagram of a recommendation procedure of a media sharing room according to an embodiment of this application.

FIG. 21 is a schematic diagram of a recommendation procedure of a media sharing room according to an embodiment of this application.

FIG. 22 is a schematic diagram of a structure of an electronic device 500 for implementing a method for recommending a media sharing room according to an embodiment of this application.

FIG. 23 is a schematic diagram of a structure of an apparatus for recommending a media sharing room according to an embodiment of this application.

### DESCRIPTION OF EMBODIMENTS

To make the objectives, technical solutions, and advantages of this application clearer, the following describes this application in further detail with reference to the accompanying drawings. The described embodiments are not to be considered as a limitation to this application. All other embodiments obtained by a person of ordinary skill in the art without creative efforts shall fall within the protection scope of this application.

In the following descriptions, related “some embodiments” describe a subset of all possible embodiments. However, the “some embodiments” may be the same subset or different subsets of all the possible embodiments, and may be combined with each other without conflict.

In the following descriptions, the included term “first/second/third” is merely intended to distinguish similar objects but does not necessarily indicate a specific order of an object. “First/second/third” is interchangeable in terms of a specific order or sequence if permitted, so that the embodiments of this application described herein can be implemented in a sequence in addition to the sequence shown or described herein.

Unless otherwise defined, meanings of all technical and scientific terms used in this specification are the same as those usually understood by a person skilled in the art to which this application belongs. Terms used in this specification are merely intended to describe objectives of embodiments of this application, but are not intended to limit this application.

Before the embodiments of this application are further described in detail, a description is made on nouns and terms involved in the embodiments of this application, and the nouns and terms involved in the embodiments of this application are applicable to the following explanations.
(1) A client is an application run on a terminal that is configured to provide various services, for example, a media (such as a video and an audio) playback client.
(2) “In response to” is used for representing a condition or status on which one or more operations to be performed depend. When the condition or status is met, the one or more operations may be performed immediately or after a set delay. Unless otherwise specified, there is no restriction on the order in which the operations are performed.
(3) A media sharing room (room) may also be referred to as a co-viewing room. The media sharing room is configured for a plurality of objects who join the media sharing room to view media content (for example, view a video and listen to an audio) played in the media sharing room. The plurality of objects in the media sharing room include a creator (namely, a room creator) and a viewer (namely, a viewer). The creator may control a playing progress of the media content and switch the played media content, and the viewer may view the played media content in synchronization with the creator.

In this embodiment of this application, the media sharing room is further configured for a live stream object among the plurality of objects to perform live streaming in the media sharing room, and for a non-live stream object among the plurality of objects to view live stream content of the live stream object. Accordingly, an effect that the live stream object views the media content together with the viewer may be achieved. Therefore, the media sharing room may also be referred to as the co-viewing room. The live stream object is also referred to as a live stream host, and corresponds to a live stream object end (or referred to as a live stream host end or a live stream end). The live stream object may be an object (such as a guest, a star, or a creator) having a permission to perform live streaming in the media sharing room. The non-live stream object is also referred to as a viewer, and corresponds to a non-live stream object end (or referred to as a viewing end).
(4) A Bloom filter (BF) is configured to determine whether an element exists in an element set. In this embodiment of this application, whether a user is located in a recommended area of a media sharing room is determined based on the Bloom filter.
(5) A spatial Bloom filter (SBF) is a variant of a Bloom filter. An ordinary Bloom filter only supports a query of a single element set, and priorities of elements in the element set cannot be divided. The spatial Bloom filter may support a plurality of element sets, and each element set includes elements with the same priority.
(6) Homomorphic encryption (HE) is an encryption form that allows a specific form of algebraic operation to be performed on ciphertext. An operation result obtained by performing an algebraic operation on the ciphertext is equivalent to an operation result obtained by performing an algebraic operation on plaintext. In other words, the homomorphic encryption may perform operations such as retrieval and comparison on encrypted data, to obtain a correct result, without decrypting the data in the entire processing process. The homomorphic encryption is used, so that the data may be “available but invisible”.
(7) Multiplicative homomorphic encryption (MHE) supports homomorphic encryption of a multiplication operation.
(8) A location based service (LBS) obtains the current location of a positioning device by using various types of positioning technologies, and provides information resources and a basic service for the positioning device through mobile internet.

Embodiments of this application provide a method and apparatus for recommending a media sharing room, a device, a computer-readable storage medium, and a computer program product, to improve security of location privacy when a recommendation of the media sharing room is made based on a location. Descriptions are provided below respectively.

In the embodiments of this application, related data such as user information or user data needs to be obtained and processed after obtaining user authorization and consent. When the embodiments of this application are applied to specific products or technologies, user permission or consent needs to be obtained, and collection, use, and processing of the related data need to comply with related laws, regulations, and standards of related countries and regions.

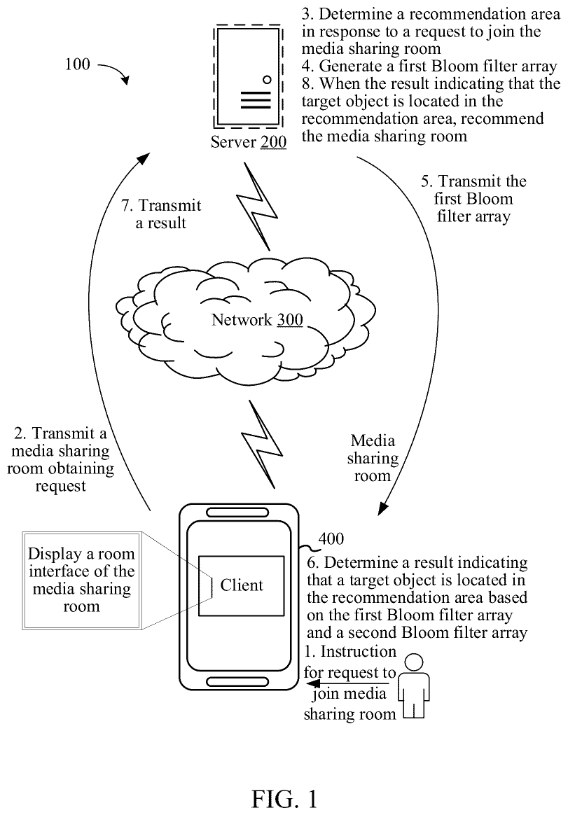

Based on the foregoing explanations of terms in the embodiments of this application, the following describes a recommendation system of a media sharing room provided in the embodiments of this application. FIG. 1 is a schematic diagram of an architecture of a recommendation system 100 of a media sharing room according to an embodiment of this application. To support an exemplary application, a terminal 400 is connected to a server 200 through a network 300. The network 300 may be a wide area network or a local area network, or a combination thereof. Data transmission is implemented by using a wireless or wired link.

The terminal 400 (which may be provided with a client supporting the media sharing room) is configured to transmit a request to join a media sharing room to the server 200 in response to an instruction to join media sharing room by a target object.

The server 200 is configured to receive the request to join a media sharing room transmitted by the terminal 400; determine, in response to the request to join a media sharing room, a recommended area associated with a to-be-recommended media sharing room; generate a first Bloom filter array corresponding to a location of the recommended area, and transmit the first Bloom filter array to a terminal 400 of the target object, where a distance between the recommended area and a creator of the media sharing room is less than a distance threshold, and the media sharing room is configured for at least one viewer who joins the media sharing room to view media content played in the media sharing room.

The terminal 400 is further configured to receive the first Bloom filter array transmitted by the server 200; generate a second Bloom filter array corresponding to a location of the target object; and determine, based on the first Bloom filter array and the second Bloom filter array, a result indicating whether the target object is located in the recommended area, and return the result to the server 200.

The server 200 is further configured to recommend the media sharing room to the terminal 400 when a result indicating that the target object is located in the recommended area is received.

The terminal 400 is further configured to receive the media sharing room recommended by the server 200, and display a room interface of the media sharing room, for the target object to view the media content played in the media sharing room.

In some embodiments, the method for recommending a media sharing room provided in the embodiments of this application may be implemented by various electronic devices, for example, may be implemented by the terminal alone, or may be implemented by the server alone, or may be implemented by the terminal and the server collaboratively. The method for recommending a media sharing room provided in the embodiments of this application may be applied to various scenarios, including but not limited to cloud technology, artificial intelligence, intelligent transportation, audio and video, assisted driving, and the like.

In some embodiments, an electronic device that implements the method for recommending a media sharing room provided in the embodiments of this application may be various types of terminals or servers. The server (for example, the server 200) may be an independent physical server, or may be a server cluster including a plurality of physical servers or a distributed system. The terminal (such as the terminal 400) may be a smartphone, a tablet computer, a notebook computer, a desktop computer, an intelligent voice interaction device (such as a smart speaker), a smart home appliance (such as a smart TV), a smart watch, a vehicle-mounted terminal, or the like, but is not limited thereto. The terminal and the server may be directly or indirectly connected in a wired or wireless communication manner. This is not limited in the embodiments of this application.

In some embodiments, the method for recommending a media sharing room provided in the embodiments of this application may be implemented by using the cloud technology. The cloud technology is a hosting technology that unifies a series of resources such as hardware, software, and networks in a wide area network or a local area network to implement computing, storage, processing, and sharing of data. The cloud computing technology becomes an important support. A backend service of a technical network system requires a large quantity of computing resources and storage resources. For example, the server (for example, the server 200) may be further a cloud server providing basic cloud computing services, such as a cloud service, a cloud database, cloud computing, a cloud function, cloud storage, a network service, cloud communication, a middleware service, a domain name service, a security service, a content delivery network (CDN), big data, and an artificial intelligence platform.

In some embodiments, a plurality of servers may form a blockchain, and the servers are nodes on the blockchain. Each node in the blockchain may have an information connection, and the nodes may transmit information through the information connection. Data (for example, information related to the media sharing room and a recommended area associated with the media sharing room) related to the method for recommending a media sharing room provided in the embodiments of this application may be saved on the blockchain.

In some embodiments, the terminal or the server may implement the method for recommending a media sharing room provided in the embodiments of this application by running various computer-executable instructions or computer programs. For example, the computer-executable instructions may be a microprogram-level command, machine instructions, or software instructions. The computer program may be a native program or a software module in an operating system; may be a native application (APP), namely, a program that needs to be installed in an operating system to run, such as a video APP or an audio APP; or may be a mini program that may be embedded in any APP, namely, a program that only needs to be downloaded into a browser environment to run. In summary, the computer-executable instructions or the computer program may be any form of application, module, or plug-in.

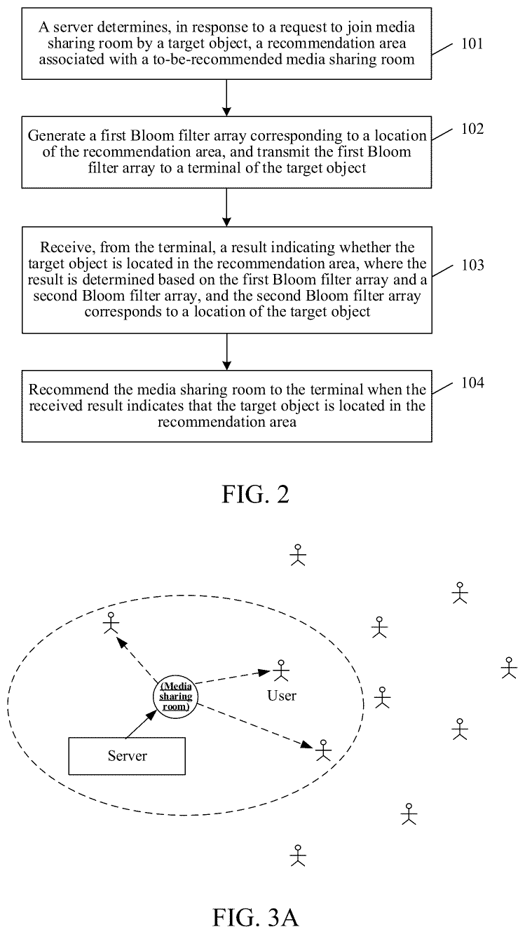

The following describes the method for recommending a media sharing room provided in the embodiments of this application. In some embodiments, the method for recommending a media sharing room provided in the embodiments of this application may be implemented by various electronic devices, for example, may be implemented by the terminal alone, or may be implemented by the server alone, or may be implemented by the terminal and the server collaboratively. An example in which the server is implemented alone is used. FIG. 2 is a schematic flowchart of a method for recommending a media sharing room according to an embodiment of this application. The method for recommending a media sharing room provided in the embodiment of this application includes:

Operation 101: The server determines, in response to a request to join a media sharing room by a target object, a recommended area associated with a to-be-recommended media sharing room.

A distance between the recommended area and a creator of the media sharing room is less than a distance threshold, and the media sharing room is configured for at least one viewer who joins the media sharing room to view media content played in the media sharing room.

In operation 101, the server may be a server that provides a related service (for example, a recommendation service) of the media sharing room. In one embodiment, a user may join the media sharing room through a held terminal, and the server may support the related service for the media sharing room on the terminal by communicating with the terminal, so that the user may view the media content played in the media sharing room. The terminal may be provided with a client. The client may be a client supporting a function of the media sharing room, for example, a video client supporting the function of the media sharing room, an audio client supporting the function of the media sharing room, or an instant messaging client supporting the function of the media sharing room.

In one embodiment, before operating the held terminal to enter the media sharing room, the user (namely, the target object) may request the server to obtain a to-be-entered media sharing room, that is, the target object transmits the request to join a media sharing room to the server through the held terminal. After receiving the request to join a media sharing room transmitted by the terminal of the target object, the server determines, in response to the request to join a media sharing room, and for at least one to-be-recommended media sharing room, a recommended area associated with each to-be-recommended media sharing room, to determine, based on whether the target object is located in the recommended area, whether to recommend the media sharing room to the target object. The distance between the recommended area and the creator of the media sharing room is less than the distance threshold. Accordingly, the user can join a to-be-recommended media sharing room near (at a distance less than a specific threshold) a location of the user. For the creator of the media sharing room, a created media sharing room may also be recommended to a user near (at a distance less than a specific threshold) a location of the creator.

The user, namely, the target object, mentioned in the embodiments of this application may be an object corresponding to an account to which the client is currently logged in, or may be an object that uses the current client when the client is currently in a non-logged-in state.

In some embodiments, before the determining, in response to a request to join a media sharing room by a target object, a recommended area associated with a to-be-recommended media sharing room, the server may further perform the following processing: establishing a persistent communication connection to the terminal when detecting that the target object triggers an opening operation on a media sharing room recommendation interface, and adding the target object to a to-be-recommended object list of the media sharing room; and correspondingly, disconnecting the persistent communication connection to the terminal after target duration when the server detects that the target object triggers an exit operation on the media sharing room recommendation interface.

In one embodiment, the target object may obtain the media sharing room on the media sharing room recommendation interface. The server may establish, when detecting that the target object triggers an opening operation on the media sharing room recommendation interface, the persistent communication connection to the terminal of the target object, and add the target object to the to-be-recommended object list of the media sharing room. The to-be-recommended object list includes a plurality of objects on which recommendation of the media sharing room is to be performed. Accordingly, the terminal may respond at the quickest speed when obtaining the media sharing room, to improve user experience. In addition, when the server detects that the target object triggers an exit operation on the media sharing room recommendation interface, the server may break the persistent communication connection to the terminal, to reduce server resources and communication resources that are occupied. In some embodiments, the server may disconnect the persistent communication connection to the terminal after the target duration (for example, 30 seconds or one minute), to avoid a case in which the target object opens the media sharing room recommendation interface again within a short period of time, resulting in a need to establish the persistent communication connection again. Accordingly, utilization of the established persistent communication connection may be improved, and a case in which the persistent communication connection is established for the same user for a plurality of times within the short period of time is avoided.

In some embodiments, in one embodiment, the target object may preset an associated target media sharing room. For example, the target object may follow the target media sharing room. Accordingly, after receiving the request to join a media sharing room, the server may recommend the target media sharing room associated with the target object to the terminal of the target object. Based on this, in response to the request to join a media sharing room by the target object, the server may determine the recommended area associated with the to-be-recommended media sharing room in the following manner: determining, in response to the request to join a media sharing room by the target object, whether the target object has an associated target media sharing room; and determining, when the target object does not have the associated target media sharing room, the recommended area associated with the to-be-recommended media sharing room. Accordingly, the target media sharing room associated with the target object is recommended to the target object, to improve recommendation efficiency and a recommendation effect of the media sharing room.

In some embodiments, when determining the recommended area associated with the to-be-recommended media sharing room, the server may implement in the following manner: determining a plurality of candidate recommended areas obtained through pre-division; obtaining first location information of the creator of the media sharing room, and obtaining area location information of each candidate recommended area; determining a distance between the creator and each candidate recommended area based on the first location information and the area location information; and identifying the candidate recommended area corresponding to the distance less than the distance threshold as the recommended area associated with the media sharing room.

In one embodiment, the target area may be pre-divided according to a division rule, to obtain a plurality of candidate recommended areas. The target area may be preset. For example, the target area may be an area A, a province B, or the like. After the plurality of candidate recommended areas are determined, first location information of the creator of the media sharing room is obtained, and area location information of each candidate recommended area is obtained. The area location information may be represented by location information of one site (for example, a center site, an upper left corner site, or a lower left corner site of the candidate recommended area) in the candidate recommended area. Then, a distance between the creator and each candidate recommended area is determined based on the first location information and the area location information, so that the candidate recommended area whose distance from the creator is lower than the distance threshold is used as the recommended area associated with the media sharing room. Accordingly, for the creator of the media sharing room, a created media sharing room may be recommended to a user located in an area (at a distance lower than the distance threshold) near the location of the creator, to improve a recommendation effect of the media sharing room.

Operation 102: Generate a first Bloom filter array corresponding to a location of the recommended area, and transmit the first Bloom filter array to the terminal of the target object.

After determining the recommended area associated with the to-be-recommended media sharing room, in operation 102, the server generates the first Bloom filter array corresponding to the location of the recommended area, and transmits the first Bloom filter array to the terminal of the target object. After receiving the first Bloom filter array, the terminal of the target object determines, based on the first Bloom filter array and a second Bloom filter array (corresponding to a location of the target object), whether the target object is located in the recommended area, and returns a result configured for representing whether the target object is located in the recommended area to the server.

In some embodiments, the server may generate the first Bloom filter array corresponding to the location of the recommended area in the following manner: determining an quantity of recommended areas, and constructing an initial Bloom filter array based on the quantity of recommended areas; obtaining at least one objective function configured for generating the first Bloom filter array; and mapping the location of the recommended area into the initial Bloom filter array based on the at least one objective function, to obtain the first Bloom filter array.

In one embodiment, a Bloom filter array corresponding to the location of the recommended area is generated includes: mapping the location of each recommended area into one array (including a plurality of elements). The array may be a binary array, a ternary array, an octal array, or the like. Specifically, one initial Bloom filter array may be constructed according to the quantity of recommended areas of the recommended area, where each element in the initial Bloom filter array is 0; then, at least one objective function configured for generating the first Bloom filter array is obtained, where the objective function may be a hash function; and finally, the location of the recommended area is mapped into the initial Bloom filter array based on the at least one objective function, to obtain the first Bloom filter array. Accordingly, the location of the recommended area is mapped into the Bloom filter array. This may ensure security of the real location of the recommended area whose distance from the creator is lower than the distance threshold.

In some embodiments, the server may construct the initial Bloom filter array based on the quantity of recommended areas in the following manner: obtaining a misjudgment score corresponding to the first Bloom filter array, where the misjudgment score indicates a possibility that the result determined based on the first Bloom filter array is a wrong result, and the result is a result obtained by determining whether the target object is located in the recommended area; determining an element quantity of elements included in the initial Bloom filter array based on the quantity of recommended areas and the misjudgment score; and constructing an array including a quantity of elements as the initial Bloom filter array, the quantity of the elements being equal to the element quantity.

In one embodiment, when the initial Bloom filter array is constructed, a misjudgment score corresponding to the first Bloom filter array may be obtained. The misjudgment score may be preset by a user, and the misjudgment score indicates the possibility that the result determined based on the first Bloom filter array is the wrong result. The misjudgment score may be preset. To make the result more accurate, when the misjudgment score is preset, the misjudgment score may be less than a misjudgment score threshold, for example, 0.01%. Then, the element quantity of the elements included in the initial Bloom filter array may be determined according to the quantity of recommended areas and the misjudgment score, so that the array including the quantity of elements may be constructed as the initial Bloom filter array, the quantity of the elements being equal to the element quantity. Accordingly, the initial Bloom filter array is constructed based on a misjudgment score corresponding to a preset area determining result. This may improve accuracy of determining the area determining result based on the first Bloom filter array, to improve recommendation precision of the media sharing room.

In some embodiments, based on the quantity of recommended areas and the misjudgment score, the element quantity of the elements included in the initial Bloom filter array may be determined by the following Formula (1):

$$m = - \frac{n ln ε}{{( ln 2 )}^{2}} \qquad Formula ( 1 )$$

n is the quantity of recommended areas, m is the element quantity, and ε is the misjudgment score.

In some embodiments, the server may obtain at least one objective function configured for generating the first Bloom filter array in the following manner: determining a function quantity of the objective function based on the quantity of recommended areas and the element quantity; and obtaining a quantity of objective functions configured for generating the first Bloom filter array, the quantity of objective functions being equal to the function quantity.

In one embodiment, the function quantity of the objective function may also be determined. Specifically, the function quantity of the objective function may be determined based on the quantity of recommended areas and the element quantity by the following Formula (2):

$$k = \frac{m}{n} ln 2 \qquad Formula ( 2 )$$

k is the function quantity, k is the quantity of recommended areas, and m is the element quantity.

In one embodiment, the function quantity of the objective function may alternatively be determined directly based on the misjudgment score by the following Formula (3):

$$k = - \frac{ln ε}{ln 2} \qquad Formula ( 3 )$$

k is the function quantity, and ε is the misjudgment score.

In some embodiments, when the quantity of recommended areas of the recommended area is more than one, the server may construct the initial Bloom filter array based on the quantity of recommended areas in the following manner: obtaining a recommendation priority of each recommended area, where the recommendation priority indicates a priority of recommending the media sharing room to an object located in the recommended area; and constructing an initial Bloom filter array in a binary format based on the quantity of recommended areas when the recommendation priorities of the recommended area are the same, where each element in the initial Bloom filter array is 0.

Correspondingly, the server may map, in the following manner, the location of the recommended area into the initial Bloom filter array based on the at least one objective function, to obtain the first Bloom filter array: separately performing the following processing for each recommended area, to obtain the first Bloom filter array: determining a function value of each objective function based on the location of the recommended area, where the function value indicates an element location of the element into which the location of the recommended area is mapped in the initial Bloom filter array; setting, for each function value, the element in the initial Bloom filter array whose element location is the function value to 1, to map the location of the recommended area into the initial Bloom filter array.

In one embodiment, when the quantity of recommended areas of the recommended area is more than one, a recommendation priority of each recommended area may be obtained, where the recommendation priority indicates a priority of recommending the media sharing room to an object located in the recommended area. When the recommendation priority of each recommended area is the same (that is, each recommended area corresponds to the same recommendation priority), the initial Bloom filter array in the binary format is constructed (that is, elements in the generated first Bloom filter array may be only 0 or 1), where elements in the initial Bloom filter array are 0. Based on this, when the location of the recommended area is mapped into the initial Bloom filter array, because each recommended area corresponds to the same recommendation priority, elements in the initial Bloom filter array into which the location of each recommended area is mapped may be the same, that is, the elements into which the location of each recommended area is mapped in the initial Bloom filter array all may be 1.

Still, the following processing is separately performed for each recommended area, to obtain the first Bloom filter array: determining a function value of each objective function based on the location of the recommended area. Specifically, hash processing may be separately performed on the location of the recommended area by using each hash function, to obtain a corresponding function value. Because the function value indicates the element location of the element into which the location of the recommended area is mapped in the initial Bloom filter array, for each function value, the element in the initial Bloom filter array whose element location is the function value is set as one, to map the location of the recommended area into the initial Bloom filter array.

Through application of the foregoing embodiments, if the plurality of recommended areas are of the same recommendation priority, the constructed initial Bloom filter array may be a binary array, and the elements into which the location of each recommended area is mapped in the initial Bloom filter array are also the same. This may simplify generation of the Bloom filter array, improve generation efficiency, and improve recommendation efficiency of the media sharing room.

In some embodiments, when the quantity of recommended areas is more than one, the server may construct the initial Bloom filter array based on the quantity of recommended areas in the following manner: obtaining a recommendation priority of each recommended area, where the recommendation priority indicates a priority of recommending the media sharing room to an object located in the recommended area; and when different recommendation priorities exist and a quantity of different recommendation priorities is more than one, constructing an initial Bloom filter array in an m-ary format, where each element in the initial Bloom filter array is 0, and m is an integer greater than the quantity of recommendation priorities.

Correspondingly, the server may map, in the following manner, the location of the recommended area into the initial Bloom filter array based on the at least one objective function, to obtain the first Bloom filter array: separately performing the following processing for each recommended area, to obtain the first Bloom filter array: determining a function value of each objective function based on the location of the recommended area, where the function value indicates an element location of the element into which the location of the recommended area is mapped in the initial Bloom filter array; obtaining a target value corresponding to the recommendation priority of the recommended area, where the target value is an integer greater than 0 and less than m, and the target value is positively correlated to the recommendation priority; and setting, for each function value, the element in the initial Bloom filter array whose element location is the function value to the target value, to map the location of the recommended area into the initial Bloom filter array.

In one embodiment, when the quantity of recommended areas is more than one, a recommendation priority of each recommended area may be obtained, where the recommendation priority indicates a priority of recommending the media sharing room to an object located in the recommended area. When different recommendation priorities exist and a quantity of different recommendation priorities is more than one, an initial Bloom filter array in an m-ary format is constructed, where m is an integer greater than the quantity of recommendation priorities. In other words, element values of the elements in the initial Bloom filter array may be integers belonging to [0, m]. Accordingly, the elements into which locations of the recommended areas with different recommendation priorities are mapped in the initial Bloom filter array may be set as different element values, to represent, through different element values, that the recommended areas correspond to different recommendation priorities.

Still, the following processing is separately performed for each recommended area, to obtain the first Bloom filter array: determining a function value of each objective function based on the location of the recommended area. Specifically, hash processing may be separately performed on the location of the recommended area by using each hash function, to obtain a corresponding function value. Because the function value indicates the element location of the element into which the location of the recommended area is mapped in the initial Bloom filter array, for each function value, the element in the initial Bloom filter array whose element location is the function value is set as a target value corresponding to the recommendation priority of the recommended area, to map the location of the recommended area into the initial Bloom filter array. Specifically, the target value corresponds to the recommendation priority of the recommended area, the target value is an integer belonging to (0, m), and the target value is positively correlated to the recommendation priority.

For example, if a quantity of recommendation priorities is three, and the recommendation priorities are, in descending order, a level 3, a level 2, and a level 1, m may be an integer greater than three, such as four, eight, or ten. To be specific, the initial Bloom filter array may be a four-ary array, an eight-ary array, a ten-ary array, or the like. An example in which the initial Bloom filter array is the eight-ary array is used. The element value of the element in the initial Bloom filter array may be [0, 7]. Correspondingly, the target value is an integer belonging to (0, 7]. For example, target values respectively corresponding to the recommendation priorities “level 3, level 2, and level 1” may be “three, two, and one”. To be specific, when the location of each recommended area is mapped into the initial Bloom filter array, the elements into which the location of each recommended area is mapped in the initial Bloom filter array may be respectively set as “three, two, and one” according to the recommendation priority of each recommended area. Accordingly, when the element into which the location of the recommended area is mapped in the initial Bloom filter array is three, the recommendation priority of the recommended area is the level 3.

Through application of the foregoing embodiments, if the plurality of recommended areas correspond to different recommendation priorities, and a quantity of different recommendation priorities is more than one, the elements into which the locations of the recommended areas with different recommendation priorities are mapped in the initial Bloom filter array may be set as different element values, so that the different recommendation priorities corresponding to the recommended areas are represented by different element values. Accordingly, when a recommendation of the media sharing room is made, location privacy may be protected, and a recommendation may be made based on the recommendation priorities. This improves the recommendation effect of the media sharing room.

Operation 103: receive, from the terminal, a result indicating whether the target object is located in the recommended area.

The result is determined based on the first Bloom filter array and a second Bloom filter array, and the second Bloom filter array corresponds to the location of the target object. The second Bloom filter array is generated based on the location of the target object.

In operation 103, the result indicates whether the target object is located in the recommended area. The location of the target object is actually the location of an object area in which the target object is located. The object area may be one of the plurality of candidate recommended areas obtained by dividing the target area according to the division rule.

Operation 104: Recommend the media sharing room to the terminal when the result indicates that the target object is located in the recommended area.

In operation 104, after receiving the result returned by the terminal, the server determines, according to the result, whether to recommend the media sharing room to the terminal of the target object. Specifically, when receiving the result indicating that the target object is located in the recommended area, the server recommends the media sharing room to the terminal of the target object; and when receiving a result indicating that the target object is not located in the recommended area, the server does not recommend the media sharing room to the terminal of the target object. Operation 103 and operation 104 are described in detail below.

In operation 103, the terminal receives the first Bloom filter array transmitted by the server, and further generates the second Bloom filter array corresponding to the location of the target object. In one embodiment, a generation manner of the second Bloom filter array and a generation manner of the first Bloom filter array may be the same. Parameters required for generating the second Bloom filter array and parameters required for generating the first Bloom filter array are the same. To be specific, the second Bloom filter and the first Bloom filter correspond to the same parameters. The parameters include: the function quantity k, the element quantity m, and the misjudgment score ¿ of the objective function. In some embodiments, the parameters may be agreed in advance by the terminal and the server, or may be transmitted to the terminal when the server transmits the first Bloom filter.

Specifically, when the second Bloom filter array corresponding to the location of the target object is generated, an array including a quantity m of elements may be first constructed as the initial Bloom filter array, the quantity of the elements being equal to the element quantity, and each element in the initial Bloom filter array is 0; and then, the location of the target object is mapped into the initial Bloom filter array based on objective functions of the function quantity k, to obtain the second Bloom filter array. Because the quantity of locations of the target object may be only one, the initial Bloom filter array is a binary array. When the location of the target object is mapped into the initial Bloom filter array, a function value of each objective function may be determined based on the location of the target object. Specifically, hash processing may be separately performed on the location of the target object by using each hash function, to obtain a corresponding function value. Because the function value indicates the element location of the element into which the location of the target object is mapped in the initial Bloom filter array, for each function value, the element in the initial Bloom filter array whose element location is the function value is set as 1, to map the location of the target object into the initial Bloom filter array, to obtain the second Bloom filter array.

In operation 103, after obtaining the second Bloom filter array, the terminal determines, based on the first Bloom filter array and the second Bloom filter array, whether the target object is located in the recommended area, to obtain a corresponding result, and returns the result to the server. Accordingly, the location of the target object does not need to be returned to the server. This ensures privacy security of the location of the target object.

In some embodiments, after receiving the first Bloom filter array transmitted by the server, the terminal of the target object may determine a result indicating whether the target object is located in the recommended area based on the first Bloom filter array and the second Bloom filter array in the following manner, and return the result to the server: determining locations at which non-0 element are located in the second Bloom filter array as the first locations; determining, for the first Bloom filter array, whether target locations in the first Bloom filter array are all non-0 elements; when determining that the target locations in the first Bloom filter array are all non-0 elements, determining that the target object is located in the recommended area, and in this case, returning a result indicating that the target object is located in the recommended area to the server; and when determining that not all target locations in the first Bloom filter array are non-0 elements, determining that the target object is not located in the recommended area, and in this case, returning a result indicating that the target object is not located in the recommended area to the server. The target locations are the same as the first locations.

Parameters used during generation of the first Bloom filter array and the second Bloom filter array are the same. The parameters include: the function quantity k, the element quantity m, and the misjudgment score ε of the objective function. Therefore, the element quantity of the elements included in the first Bloom filter array and the element quantity of the elements included in the second Bloom filter array are the same. Based on this, in this embodiment of this application, when whether the target object is located in the recommended area is determined, it is determined whether the target locations in the first Bloom filter array are all non-0 elements. The target locations are the same as the first locations. The first locations are locations at which the non-0 elements are located in the second Bloom filter array. For example, if the first location is “a location at which a second element in the array is located”, the target location is also “a location at which the second element in the array is located”.

Accordingly, after transmitting the first Bloom filter array to the terminal of the target object, the server receives a result returned by the terminal, where the terminal is configured to return, when determining that the target locations in the first Bloom filter array are all non-0 elements, a result indicating that the target object is located in the recommended area; and return, when determining that not all target locations in the first Bloom filter array are non-0 elements, a result indicating that the target object is not located in the recommended area, where the target locations are the same as the locations (namely, the foregoing first locations) at which non-0 elements in the second Bloom filter array are located. After receiving the result returned by the terminal, the server determines, according to the result, whether to recommend the media sharing room to the terminal of the target object.

Through application of the foregoing embodiments, the terminal of the target object determines a result indicating whether the target object is located in the recommended area and returns the result to the server. This reduces computing complexity on the server side, reduces computing resources occupied on the server side, and reduces load on the server side, thereby improving a recommendation effect of a recommendation service of the media sharing room.

In some embodiments, after receiving the first Bloom filter array transmitted by the server, the terminal of the target object may determine the result indicating whether the target object is located in the recommended area based on the first Bloom filter array and the second Bloom filter array in the following manner, and return the result to the server: multiplying the first Bloom filter array by the second Bloom filter array, to obtain a product array; and representing, by the product array, the result indicating whether the target object is located in the recommended area, and returning the product array as the result to the server. Accordingly, after transmitting the first Bloom filter array to the terminal of the target object, the server further receives the result returned by the terminal, where the result is represented by the product array obtained by multiplying the first Bloom filter array by the second Bloom filter array; and correspondingly, the server may determine the result represented by the product array (to be specific, determine whether the product array represents that the target object is located in the recommended area or the product array represents that the target object is not located in the recommended area) in the following manner: obtaining a first quantity of non-0 elements in the product array and a second quantity of the objective function; when the first quantity is equal to the second quantity, determining that the result indicates that the target object is located in the recommended area; and when the first quantity is not equal to the second quantity, determining that the result indicates that the target object is not located in the recommended area.

Through application of the foregoing embodiments, the terminal of the target object only needs to calculate the product array of the first Bloom filter array and the second Bloom filter array and return the product array to the server, to represent the result indicating whether the target object is located in the recommended area by using the product array. Accordingly, the server side parses the product array to determine whether the target object is located in the recommended area. Accordingly, computing complexity on the terminal side is reduced, and computing resources occupied on the terminal side are reduced.

In some embodiments, after receiving the first Bloom filter array transmitted by the server, the terminal of the target object may determine a result indicating whether the target object is located in the recommended area based on the first Bloom filter array and the second Bloom filter array in the following manner, and return the result to the server: multiplying the first Bloom filter array by the second Bloom filter array, to obtain a product array; and representing, by the product array, the result indicating whether the target object is located in the recommended area, and returning the product array as the result to the server. Accordingly, after transmitting the first Bloom filter array to the terminal of the target object, the server further receives the result returned by the terminal, where the result is represented by the product array obtained by multiplying the first Bloom filter array by the second Bloom filter array; and correspondingly, the server may determine the result indicated by the product array (to be specific, determine whether the product array indicates that the target object is located in the recommended area or whether the product array indicates that the target object is not located in the recommended area) in the following manner: obtaining a first quantity of non-0 elements in the product array and a second quantity of the objective function; when the first quantity is not equal to the second quantity, determining that the result indicates that the target object is not located in the recommended area; and when the first quantity is equal to the second quantity, determining that the result indicates that the target object is located in the recommended area.

In addition, if not all non-0 elements in the product array are 1, a minimum element value of the non-0 elements and a target recommendation priority corresponding to the minimum element value are determined, to further determine that the target object is located in a target recommended area corresponding to the target recommendation priority; and correspondingly, when a quantity of to-be-recommended objects in the media sharing room is more than one, and the plurality of to-be-recommended objects include the target object, the server may recommend the media sharing room to the terminal in the following manner: determining a first recommendation priority of a recommended area in which a first to-be-recommended object is located, where the first to-be-recommended object is a to-be-recommended object in the plurality of to-be-recommended objects other than the target object; and recommending the media sharing room to the terminal when the target recommendation priority is higher than the first recommendation priority. Accordingly, location privacy may be protected, and the media sharing room may be further recommended to corresponding recommended areas based on different recommendation priorities. This improves the recommendation effect of the media sharing room.

In some embodiments, when transmitting the first Bloom filter array to the terminal of the target object, the server may further perform homomorphic encryption processing on the first Bloom filter array, to obtain an encrypted Bloom filter array; and transmit the encrypted Bloom filter array to the terminal of the target object, where the encrypted Bloom filter array is configured for the terminal to multiply the second Bloom filter array by the encrypted Bloom filter array to obtain a product array, randomly shuffle element locations of elements in the product array to obtain an out-of-order product array, and return the out-of-order product array, where the out-of-order product array indicates the result indicating whether the target object is located in the recommended area; and correspondingly, after transmitting the encrypted Bloom filter array to the terminal of the target object, the server further receives the out-of-order product array returned by the terminal.

In one embodiment, when transmitting the first Bloom filter array to the terminal of the target object, the server may further perform homomorphic encryption processing on the first Bloom filter array, to ensure data security of the first Bloom filter array, and prevent an illegal person from back inferring, according to the first Bloom filter array, a recommended area near the creator and exposing a location of the creator, thereby further improving security of the location privacy in the process of recommending the media sharing room. Accordingly, the server transmits the encrypted Bloom filter array obtained through homomorphic encryption to the terminal of the target object. Correspondingly, after receiving the encrypted Bloom filter array, the terminal may multiply the second Bloom filter array by the encrypted Bloom filter array, to obtain a product array, randomly shuffle element locations of elements in the product array, to obtain an out-of-order product array, and return the out-of-order product array to the server. The out-of-order product array indicates the result indicating whether the target object is located in the recommended area. Accordingly, the product array is randomly shuffled and the obtained out-of-order product array is returned, to ensure data security of the product array. This further improves the security of the location privacy in the process of recommending the media sharing room.

Still, the server receives the out-of-order product array returned by the terminal, to determine a result represented by the out-of-order product array based on the out-of-order product array (to be specific, determine whether the out-of-order product array represents that the target object is located in the recommended area or the product array represents that the target object is not located in the recommended area): obtaining a first quantity of non-0 elements in the out-of-order product array and a second quantity of the objective function; when the first quantity is equal to the second quantity, determining that the result indicates that the target object is located in the recommended area; and when the first quantity is not equal to the second quantity, determining that the result indicates that the target object is not located in the recommended area.

In some embodiments, the server may generate a public key and a private key configured for homomorphic encryption, and then synchronize the public key to the terminal. The server may perform homomorphic encryption processing on the first Bloom filter array by using the public key, to obtain an encrypted Bloom filter array. The terminal may also calculate a product array of the encrypted Bloom filter array and the second Bloom filter array by using the public key.

In one embodiment, the server transmits prompt information to the terminal when a target quantity of target Bloom filter arrays have been transmitted to the target object, and a result indicating that the target object is not located in a corresponding recommended area is received by each target Bloom filter array, where the target Bloom filter array corresponds to a target media sharing room, and the prompt information is configured for prompting the target object to re-transmit the obtaining request after target duration. Accordingly, when the server attempts to transmit Bloom filters of media sharing rooms of the target quantity to the terminal, and does not receive the result indicating that the target object is located in the corresponding recommended area, it represents that there is no suitable media sharing room near (the distance from the target object is lower than a specific threshold) the target object. In this case, the recommendation for the media sharing room of the target object may be temporarily aborted, and corresponding prompt information is returned to the terminal of the target object, to prompt the target object to retry again after target duration (for example, ten minutes), that is, transmit the obtaining request again after the target duration.

Through application of the foregoing embodiments of this application, after receiving a request to join a media sharing room from the target object, the recommended area associated with the to-be-recommended media sharing room is determined, the first Bloom filter array corresponding to the location of the recommended area is generated, and the first Bloom filter array is transmitted to the terminal of the target object, so that the terminal of the target object determines, based on the first Bloom filter array and the second Bloom filter array, the result indicating whether the target object is located in the recommended area, and returns the result. When the result indicating that the target object is located in the recommended area is received, the media sharing room is recommended to the terminal.

The distance between the recommended area and the creator of the media sharing room is less than the distance threshold. When whether the target object is located in the recommended area is determined, the first Bloom filter array corresponding to the location of the recommended area is transmitted to the terminal of the target object; and the result indicating whether the target object is located in the recommended area is returned by the terminal of the target object. Accordingly, in a process of recommending the media sharing room, the target object does not need to provide a real location of the target object to another party, and a real location of the recommended area whose distance from the creator is lower than the distance threshold also does not need to be provided to the target object. This ensures that location privacy of two parties is not disclosed, and improves security of the location privacy when a media sharing room recommendation is made based on a location.

The following describes an exemplary application of this embodiment of this application in certain embodiments. With the widespread application of a location based service LBS, the problem of location privacy protection receives attention from a plurality of parties. More and more application scenarios (such as a navigation application) of the LBS collect a real location of a user, to provide a high-quality location based service to the user. Recommending the media sharing room to a nearby person (to be specific, a user located in a recommended area whose distance from a creator of the media sharing room is lower than the distance threshold) is also an application scenario of the LBS. In the related art, implementation is generally performed in the following manner:

(1) Direct coordinate calculation: It is required that each to-be-recommended user and a creator transmit real locations to a server, and the server calculates a real distance between each to-be-recommended user and the creator according to the real location, to recommend a media sharing room to a nearby person according to the real distance. (2) Geohash algorithm+direct coordinate calculation: The Geohash algorithm is to divide all areas on the Earth into 24 blocks, and each block is represented by one character. The divided block may be further divided into 24 sub-blocks. A greater quantity of divisions indicates a longer string that is obtained and higher precision. A property of the Geohash algorithm is that a closer distance between two coordinates indicates a greater quantity of prefixes of a hash value that overlap with each other. The property and the real locations of each to-be-recommended user and the creator may be used, to determine a to-be-recommended user near the creator, and recommend the media sharing room to the nearby user. In solution (1) and solution (2) in the related art, although the LBS may be implemented, location privacy of the user is not protected, and the server may directly obtain the real location of the user. There is a risk of compromising location privacy of the user.

To resolve the problems existing in the related art, the embodiments of this application provide the following solutions, to protect the location privacy of the user in an LBS-based media sharing room recommendation scenario: (1) A solution based on hiding a user identifier. (a) k-anonymous model: There are at least k users at a specific location, and the k users cannot identify with each other through IDs. Accordingly, even if a location of a specific user is obtained by a malicious attacker, the malicious attacker or the server cannot accurately locate the specific user from the k users. (b) Pseudonym: Each user hides a real ID by using one pseudonym. Accordingly, although the malicious attacker or the server may obtain a real location of the user, the real location cannot be linked to identification information of the user, which increases difficulty of positioning a specific user and protects the location privacy of the user. (2) A solution based on fuzzy location information. (a) Wrong or false location information: The user may transmit a plurality of different locations to the server. Only one of the locations is the real location of the user, and the other locations are wrong or false locations. Accordingly, the server or the malicious attacker cannot locate the user according to the locations. (b) Road sign object: The user does not transmit the real location of the user to the server, but transmits a location of a road sign or an important object. (c) Area location information: The real location of the user is replaced with one spatial area including the real location of the user.

However, the location privacy protection solution still has the following problems: (1) The solution based on hiding the user identifier still cannot prevent snooping by the server on the real location of the user, that is, the location of the user is still transparent to the server. (2) The solution based on the fuzzy location information: (a) In the solution of the wrong or false location information, the user simultaneously provides the plurality of pieces of location information for the server end, which increases space overheads of the server and processing duration of a service request, increases difficulty of design and processing of the server, and also requires the client to have a capability of determining accuracy of service information. (b) In the solution of the road sign object, the client needs to determine which piece of information is of real interest from the information returned by the server, which increases load on the client and reduces quality of service. (c) In the solution of the area location information, when the server may use only the location area, the quality of service is greatly reduced. In addition, because the server does not know the user is at which location in the area, the server has to select some location points in the area as reference points for processing. A quantity of selected reference points is related to accuracy of information provided for the user, which increases load and response duration of the server.

It may be learned that the foregoing solutions have problems such as being unable to effectively protect the location privacy of the user, being difficult to implement, having heavy load on the server or the client, and having low quality of service. However, in a service for recommending a media sharing room provided in the embodiments of this application, the media sharing room created by the creator needs to be recommended to the nearby user, to allow other users to join the media sharing room, thereby achieving objectives of advertising, promotion, and improving user participation. Therefore, the embodiments of this application further provide a method for recommending a media sharing room, to resolve at least the foregoing problems and improve security of the location privacy.

In the embodiments of this application, protection of the location privacy includes two aspects: (1) The real location of the user cannot be obtained by a third-party attacker; and (2) the real location of the user cannot be obtained by the server. Specifically, (1) geographic location information is modeled by using a Bloom filter or a spatial Bloom filter, to fuzzify the location information of the user; (2) homomorphic encryption communication is used, to ensure that privacy data of the user location is “invisible and unavailable” to the malicious attacker, and is “unavailable and invisible” to the server, thereby ensuring that the location privacy of the user is not disclosed to the server and the malicious attacker, and ensuring end-to-end privacy security during collection, transmission, and use of the location information of the user; and (3) the server asynchronously processes a process of recommending the media sharing room in the backend, and amortizes computing load of the client.

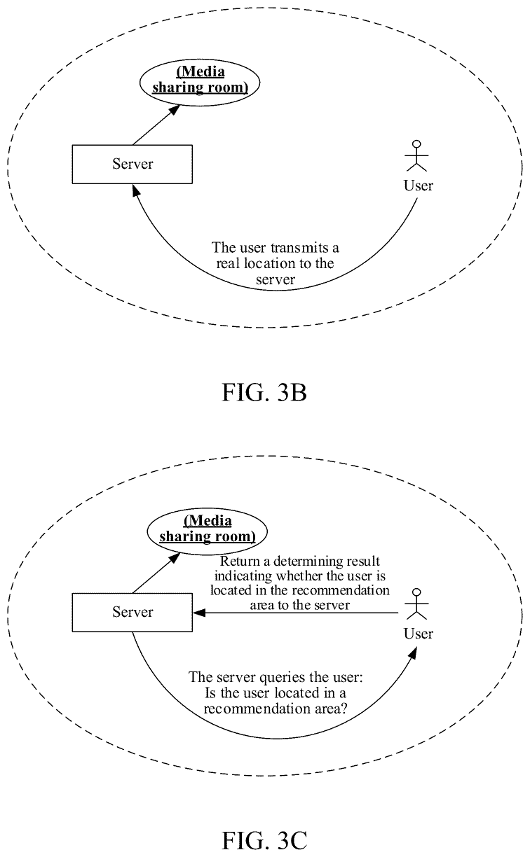

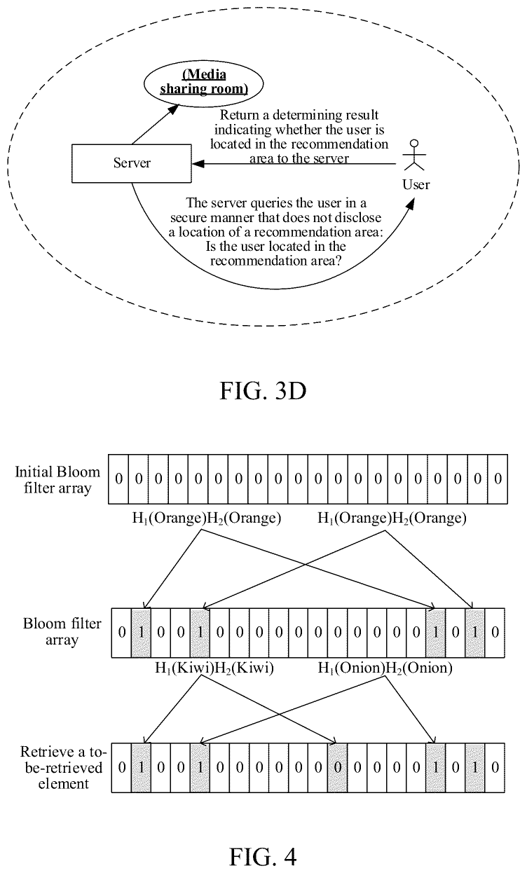

Next, the method for recommending a media sharing room provided in the embodiments of this application is described in detail from a technical side. FIG. 3A is a schematic diagram of recommendation of a media sharing room according to an embodiment of this application. In the embodiments of this application, a media sharing room created by a creator is recommended to a nearby user, so that the user joins the media sharing room. In the embodiments of this application, the “nearby user” refers to a user (namely, a user located within a dashed circle shown in FIG. 3A) located in a recommended area associated with the media sharing room. A distance between the recommended area and the creator of the media sharing room is less than a distance threshold. When making a recommendation of the media sharing room, the server needs to determine a result indicating whether the user is located in the recommended area, to make a recommendation of the media sharing room according to the result: when the result represents that the user is located in the recommended area, the media sharing room is recommended to the user; and when the result represents that the user is not located in the recommended area, the media sharing room is not recommended to the user.

Next, how to determine whether the user is located in the recommended area is described. FIG. 3B is a schematic diagram of recommendation of a media sharing room according to the related art. The server determines, by obtaining a real location of the user, whether the user is located in the recommended area, to make a recommendation of the media sharing room according to a determining result. However, there is a possibility of compromising the real location of the user. FIG. 3C is a schematic diagram of recommendation of a media sharing room according to the related art. The server queries the user whether the user is located in the recommended area. A terminal of the user determines, according to the real location of the user, whether the user is located in the recommended area queried by the server, and then returns the determining result to the server, so that the server makes a recommendation of the media sharing room according to the received determining result. However, an area of interest of the server may be exposed. That is, the user or a malicious attacker may infer a real location of the creator of the media sharing room by using the recommended area given by the server. As a result, there is a risk of compromising location privacy of the creator. Based on this, the embodiments of this application provide the following manner to determine whether the user is located in the recommended area. Detailed descriptions are provided below.

FIG. 3D is a schematic diagram of recommendation of a media sharing room according to an embodiment of this application. Although the server still needs to query whether the terminal is located in the recommended area, the server does not need to tell the terminal the real area location of the recommended area during the querying. That is, querying is performed in a secure manner that does not disclose the real area location of the recommended area. Therefore, the user or the attacker cannot learn of the area of interest of the server, and cannot learn of the real location of the creator. Accordingly, both location privacy of the user and location privacy of the creator may be protected. In one embodiment, a manner of determining whether the user is located in the recommended area shown in FIG. 3D may be implemented through a Bloom filter or a spatial Bloom filter. Descriptions are provided below respectively.

First, a Bloom filter. One target element (for example, the location of the recommended area) is mapped into the Bloom filter based on a random mapping function (for example, a hash function), to obtain one binary array, namely, a Bloom filter array. When an quantity of recommended areas of the media sharing room is more than one, the Bloom filter is applicable to a case in which recommendation priorities of the recommended areas are the same priority.

(1) A principle of the Bloom filter is that when one target element is added to a set, a target element is mapped at k locations in one binary array by using k hash functions, and values of the k locations in the binary array are set as one, to obtain a Bloom filter array. When the target element is/is not in the set is retrieved, first, the k hash functions are used to obtain the k locations, and then it is determined whether the k locations in the Bloom filter array each is one. If not, the target element is definitely not in the set, and if yes, it is possible that the target element is in the set. (2) Parameters of the Bloom filter include: (1) k: a function quantity of the hash function; (2) m: a quantity of elements (namely, 0 and 1) in the Bloom filter array, that is, a binary vector size of the Bloom filter; (3) n: a quantity, namely, the quantity of recommended areas of the foregoing recommended area, of target elements that need to be stored in the Bloom filter; and (4) p: a misjudgment rate, that is, a probability that not being in the set is mistakenly determined as being in the set, namely, the foregoing misjudgment score.

FIG. 4 is a schematic diagram of generation of a Bloom filter array according to an embodiment of this application. When a target element is added to a set, two locations are separately calculated for the target element by using two hash functions H1 and H2, and values at the two locations in an initial Bloom filter array are set as one, to obtain the Bloom filter array. When whether a to-be-retrieved element is in a set is retrieved, the two locations are also calculated for the to-be-retrieved element by using the two hash functions, and whether both the two locations in the Bloom filter array are one is checked. If both the two locations are one, the to-be-retrieved element may exist in the set; or otherwise, the to-be-retrieved element definitely does not exist in the set. It may be learnt from FIG. 4 that not both the two locations are one, and then the to-be-retrieved element does not exist in the set.

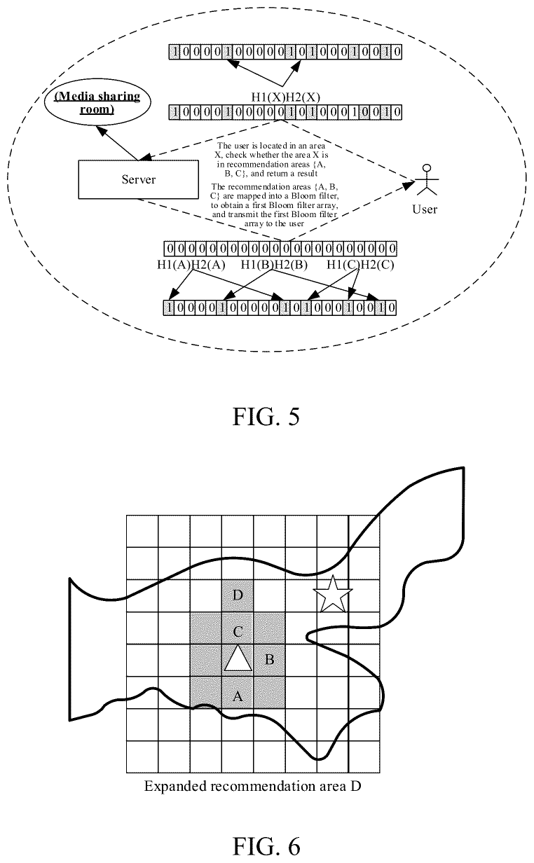

Location mapping of the Bloom filter is based on a one-way hash function (namely, the hash function). The one-way hash function is irreversible. Therefore, even if all parameters for constructing the Bloom filter are known, internal elements cannot be back inferred from a constructed Bloom filter. Accordingly, if a location of a recommended area or a location of a user is stored into the Bloom filter, the location of the recommended area or the location of the user cannot be back inferred, but it may be determined whether the location of the user is in the recommended area according to the Bloom filter. Specifically, FIG. 5 is a schematic diagram of recommendation of a media sharing room according to an embodiment of this application. A server needs to confirm to a terminal whether a user is located in a recommended area {A, B, C}. Therefore, a location of the recommended area {A, B, C} is mapped into a Bloom filter, to obtain a first Bloom filter array corresponding to the location of the recommended area, and transmit the first Bloom filter array to the terminal. The terminal generates a second Bloom filter array according to a location of the terminal, determines, according to the first Bloom filter array and the second Bloom filter array, a result indicating whether the terminal is located in the recommended area, and returns the result to the server. Then, the server may make a recommendation of the media sharing room according to the result. Specifically, the terminal determines a target location with a value of one in the second Bloom filter array, and determines whether all target locations in the first Bloom filter array are one. If yes, a result indicating that the terminal is located in the recommended area is obtained, and if not, a result indicating that the terminal is not located in the recommended area is obtained. As shown in FIG. 5, not all target locations in the first Bloom filter array are one, and therefore the user is not located in the recommended area {A, B, C}. In this process, the terminal does not need to know the location of the recommended area, and the server also does not need to know the location of the terminal. Location privacy of the two parties is protected.

Second, a spatial Bloom filter. FIG. 6 is a schematic diagram of a recommended area according to an embodiment of this application. Recommended areas associated with a media sharing room include A, B, and C. If a server wants to add a recommended area D, and the recommended area D is farther away from a real location of a creator, a recommendation priority needs to be lower than that of the recommended area A/B/C. Because elements in a set of the Bloom filter do not have priorities, differences between D and A/B/C cannot be told. Therefore, the embodiments of this application further provide a Bloom filter-spatial Bloom filter with a plurality of sets that support different priorities. When an quantity of recommended areas of the media sharing room is more than one, the spatial Bloom filter is applicable to a case in which the plurality of recommended areas correspond to different recommendation priorities, and a quantity of different recommendation priorities is more than one.

The spatial Bloom filter is different from the Bloom filter. Each location in the Bloom filter is represented by one bit. Therefore, the value of each location may be only zero or one. Each location in the spatial Bloom filter may be represented by a plurality of bits, for example, by three bits. In this case, the value of each location may be [0, 7]. Therefore, this characteristic is used to expand the quantity of bits represented by each location, and areas with different priorities may be represented. Next, a generation process of the spatial Bloom filter array is described.

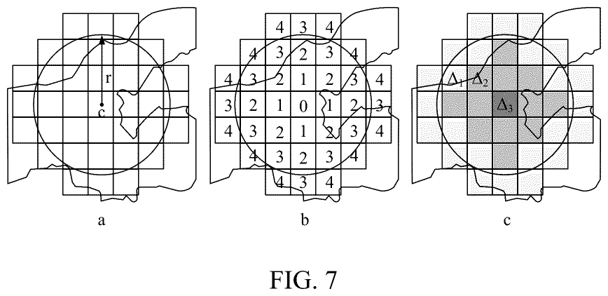

FIG. 7 is a schematic diagram of a recommended area according to an embodiment of this application. (a) A point c is a real location of a creator, and r is a range, for example, 2 km, that the creator wants to recommend to a nearby person. A circle is drawn with c as the center of the circle and r as a radius. The circle covers many candidate areas, and the candidate areas covered by the circle are used as recommended areas associated with a media sharing room of the creator. (b) A distance between a recommended area in which the point c is located and the creator is set as zero, and a Manhattan distance between each recommended area and c is calculated. (c) Recommendation priorities of the recommended areas are divided according to the Manhattan distance. A policy for dividing the recommendation priorities may be customized. As shown in FIG. 7, recommendation priorities of recommended areas at a distance of 1 and a distance of 2 are the same, and recommendation priorities of recommended areas at a distance of 3 and a distance of 4 are the same. The recommendation priorities are divided in descending order and from inside to outside of the circle. The plurality of recommended areas are divided into recommended areas: [Δ3, Δ2, Δ1] with three recommendation priorities, and values corresponding to the recommendation priorities are [3, 2, 1] respectively.

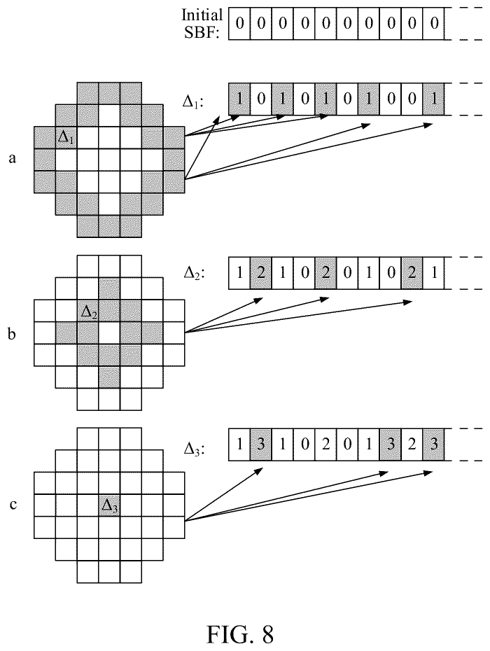

FIG. 8 is a schematic diagram of generation of a spatial Bloom filter array according to an embodiment of this application. When a spatial Bloom filter array corresponding to a recommended area is generated, for a recommended area Δ1 with a recommendation priority of 1, when Δ1 is mapped into the spatial Bloom filter, a corresponding location of Δ1 mapped into the spatial Bloom filter array is set as one. For a recommended area Δ2 with a recommendation priority of 2, when Δ2 is mapped into the spatial Bloom filter, a corresponding location of Δ2 mapped into the spatial Bloom filter array which is set as two. For a recommended area Δ3 with a recommendation priority of 3, when Δ3 is mapped into the spatial Bloom filter, a corresponding location of Δ3 mapped into the spatial Bloom filter array is set as three. Accordingly, recommendation priorities of recommended areas may be divided by using the spatial Bloom filter, so that different recommendation policies may be set for users in recommended areas with different recommendation priorities.

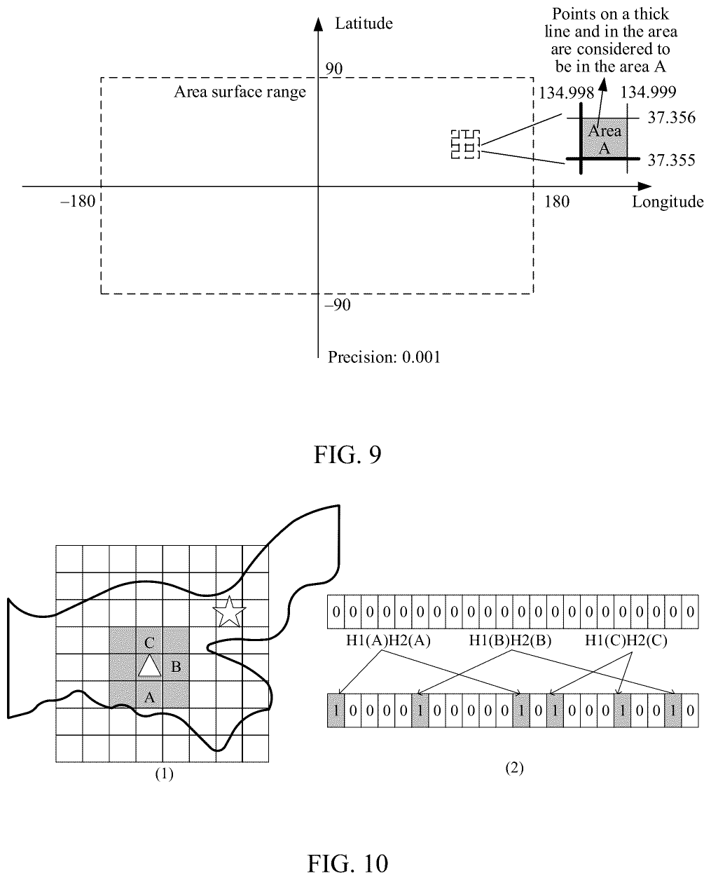

Third, area division is described. In the embodiments of this application, two parameters {longitude, dimension} are required for map modeling. FIG. 9 is a schematic diagram of area division according to an embodiment of this application. The entire earth may be abstracted into one two-dimensional plane. A longitude range is [−180, 180] and a latitude range is [−90, 90]. Then, the earth plane may be divided into a plurality of areas, such as an area A in FIG. 9, according to a preset precision (for example, 0.001). After the plurality of areas are obtained through division, each coordinate {longitude, dimension} may fall within one area. Because coordinates fall on a boundary of the area, in the embodiments of this application, for a case of the boundary, area attribution is defined. To be specific, a case in which coordinates falling on a left boundary and a lower boundary of the area also belong to the area is defined. As shown in FIG. 9, the area A is defined as {[134.998, 134.999), [37.355, 37.356)}, and the area A may be simplified to “134.998, 37.355”. The value represents an area location of the area.

After the plurality of areas are obtained through division, a recommended area associated with a media sharing room may be determined from the plurality of areas according to a location of a creator. Each recommended area is represented by an area location of the recommended area. FIG. 10 is a schematic diagram of a recommended area according to an embodiment of this application. As shown in (1) in FIG. 10, a triangle represents a location of a creator, {A, B, C} represent recommended areas of a media sharing room, and a five-pointed star represents a to-be-recommended user. As shown in (2) in FIG. 10, when a Bloom filter array is generated, locations of the recommended areas {A, B, C} may be respectively mapped into a Bloom filter based on two hash functions, and locations of the recommended areas mapped into an initial Bloom filter array of the Bloom filter are set as one, to obtain a Bloom filter array corresponding to the locations of the recommended areas.

Fourth, homomorphic encryption is described. The Bloom filter or a spatial Bloom filter is used, so that area locations of the recommended areas may be represented in a proper and simplified manner, and recommendation priorities of different recommended areas may be distinguished. To further ensure location privacy, in a process of transmitting the Bloom filter array (for example, a first Bloom filter array corresponding to the locations of the recommended areas), the Bloom filter array is encrypted. In the embodiments of this application, a manner of the homomorphic encryption may be used for implementation. The homomorphic encryption not only makes encrypted content invisible to a third-party attacker, but also makes the encrypted content invisible to a user. However, the encrypted content is available to the user, that is, data is “available but invisible”.

The homomorphic encryption allows calculation, such as addition and multiplication, to be directly performed on encrypted data, and a calculation process does not disclose any information of original text. According to a supported calculation type and a supporting degree, the homomorphic encryption may be classified into the following three types: (1) Partially homomorphic encryption (PHE): Only one operation of an addition operation or a multiplication operation is supported. The partially homomorphic encryption that supports only the addition operation is also referred to as additive homomorphic encryption (AHE). The partially homomorphic encryption that supports only the multiplication operation is also referred to as multiplicative homomorphic encryption (MHE). (2) Somewhat homomorphic encryption (SWHE): The somewhat homomorphic encryption may support both the addition operation and the multiplication operation, but supports a limited quantity of calculations. (3) Fully homomorphic encryption (FHE): The fully homomorphic encryption supports any quantity of addition operations and multiplication operations.

In some embodiments of this application, the multiplicative homomorphic encryption may be used for implementation. The multiplicative homomorphic encryption needs to satisfy Dec(Enc(p1)⊙p2)=p1*p2. Dec( ) represents decryption, Enc( ) represents encryption, p1 and p2 represent plaintext, and ⊙ represents a target operation. In other words, after a target operation is performed on ciphertext of one piece of plaintext and another piece of plaintext, a decryption result is a product of the two pieces of plaintext. It is assumed that two communication parties are a server of a media sharing room and a terminal of a to-be-recommended object. X corresponds to an SBF of the server, and Y corresponds to a BF (where there is only one area in which the user is located, and the SBF may be simplified to the BF) of the terminal. A multiplicative homomorphic encryption and decryption process is as follows.

(1) The server generates a public-private key pair (Pubkey, Prikey) required for the multiplicative homomorphic encryption and decryption, and transmits a public key Pubkey to the terminal. (2) The server performs homomorphic encryption on X by using the public key Pubkey, and transmits the encrypted SBF to the terminal, that is, E=(Enc(X)). (3) The terminal calculates C=(Enc(X)⊙Y) by using the public key Pubkey, and transmits C to the server. (4) The server receives D=Dec(C)=X*Y. Accordingly, the terminal does not know what the original X is, because the original X is encrypted. The server also does not know what the original Y is, but can know a product of X and Y through decryption.

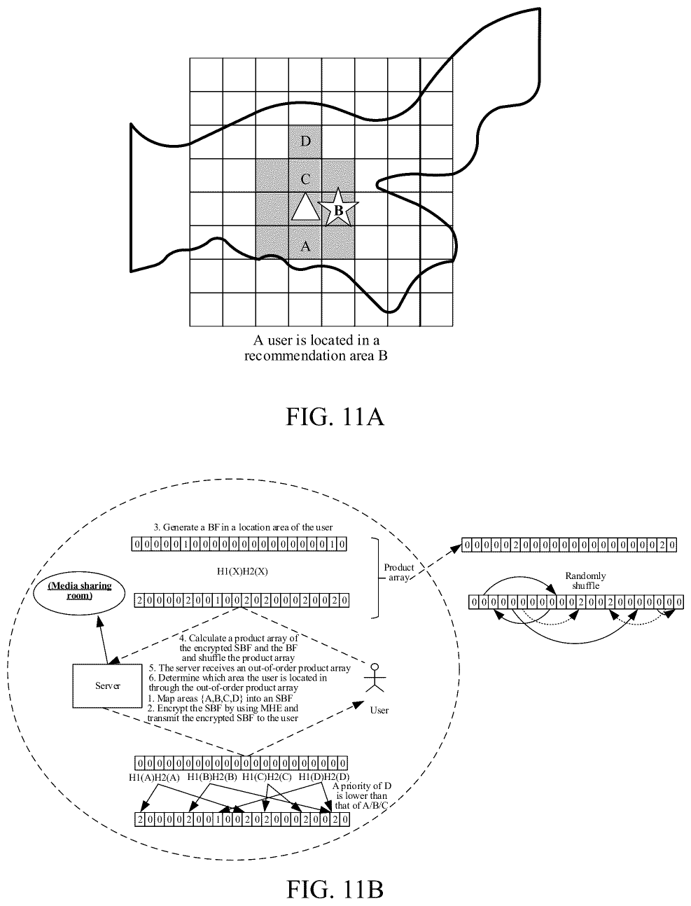

Based on the foregoing descriptions of the Bloom filter or the spatial Bloom filter and the homomorphic encryption, the following describes a procedure of the method for recommending a media sharing room provided in the embodiments of this application. FIG. 11A and FIG. 11B are schematic diagrams of recommendation of a media sharing room according to an embodiment of this application. As shown in FIG. 11A, a five-pointed star represents a user, and the user is located in a recommended area B. The recommended area includes A, B, C, and D. A recommendation priority of D is lower than that of A, B, and C. The recommendation priority of D is level 1, and a value of the recommended area D mapped at a corresponding location in the first Bloom filter array is set as one. Recommendation priorities of A, B, and C are level 2, and values of the recommended areas A, B, and C mapped at corresponding locations in the first Bloom filter array are set as two. As shown in FIG. 11B, the method for recommending a media sharing room provided in the embodiments of this application includes:
(1) The server generates a corresponding first Bloom filter array based on a location of a recommended area associated with the media sharing room. After detecting that the user opens a media sharing room recommendation interface, the server prompts the user to enable positioning (where positioning information obtained by enabling positioning is used only on a terminal of the user and is not transmitted to and stored in the server); after the user enables positioning, a persistent communication connection to the terminal of the user is established; and in this case, when a request to join a media sharing room transmitted by the terminal is received, a recommended area associated with a to-be-recommended media sharing room is determined, and a corresponding first Bloom filter array is generated based on an area location of the recommended area and k hash functions.
(2) The server generates a public-private key pair configured for multiplicative homomorphic encryption and decryption, and synchronizes a public key to the terminal. In addition, the first Bloom filter array is encrypted by using the public key, to obtain an encrypted Bloom filter array, and the encrypted Bloom filter array is transmitted to the terminal. In addition, construction parameters of the first Bloom filter array may be further transmitted to the terminal together. The construction parameters may include a quantity of hash functions, a hash function, an element quantity of elements in the first Bloom filter array, and the like.
(3) The terminal generates a second Bloom filter array based on the real location of the terminal and the construction parameters. There is only one area for the terminal, and in this case, an SBF may be simplified to a BF. To be specific, a value of a terminal location mapped at a corresponding location in the second Bloom filter array is set as one.
(4) The user end performs a homomorphic product operation on the second Bloom filter array and the encrypted Bloom filter array by using the public key, to obtain a product array, and randomly shuffles locations of elements in the product array, to prevent the server from back inferring an area in which a client is located, to obtain an out-of-order product array. The out-of-order product array is then transmitted to the server.
(5) The server receives the out-of-order product array.
(6) The server determines, according to the out-of-order product array, whether the terminal is located in the recommended area and in which recommended area the terminal is located. Specifically, a quantity of non-0 elements in the out-of-order product array is obtained, and a value relationship between the quantity of non-0 elements and a quantity of hash functions in the construction parameters is determined. If the quantity of non-0 elements is less than the quantity of hash functions, it is determined that the terminal is not located in the recommended area. If the quantity of non-0 elements is equal to the quantity of hash functions, it is determined that the terminal is located in the recommended area. In this case, a minimum element value of the non-0 elements may be further determined. A recommendation priority corresponding to the minimum element value is a recommendation priority of the recommended area in which the user is located. As shown in FIG. 11B, the server may learn of a case in which the terminal is located in the recommended areas A, B, and C.

Accordingly, if the user is not located in the recommended area associated with the media sharing room, the server cannot obtain any information of the user. If the user is located in the recommended area associated with the media sharing room, the server may also know only an area set to which the recommended area in which the user is located belongs, and cannot know area information and a precise location of an area in which the user is located. The user also cannot learn of the recommended area associated with the media sharing room, and cannot deduce an area in which a creator is located. Therefore, the respective location privacy of the two parties is protected.

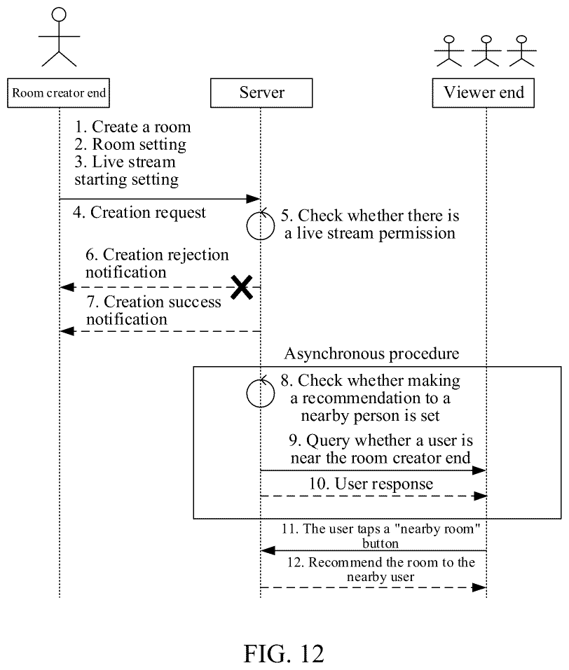

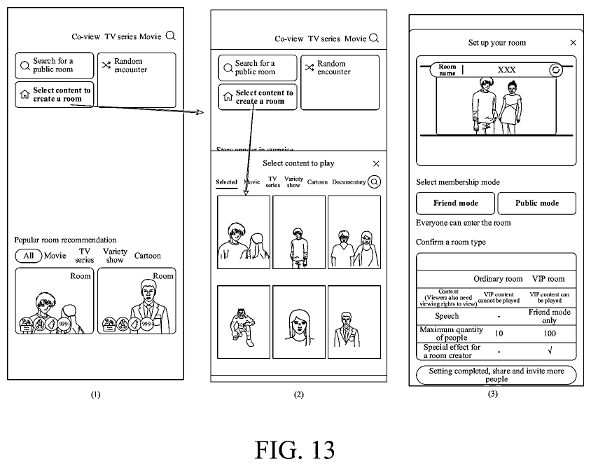

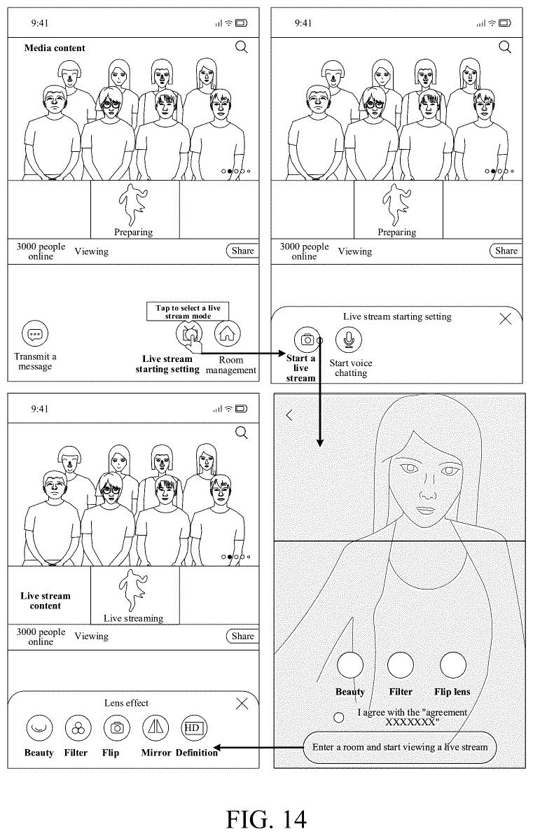

The following continues to describe the method for recommending a media sharing room provided in the embodiments of this application. FIG. 12 is a schematic flowchart of a method for recommending a media sharing room according to an embodiment of this application. The method includes: 1. creating a room: A room creator end triggers a creation instruction of the media sharing room; 2. room setting: triggering a setting operation for the media sharing room; 3. live stream starting setting; 4. transmitting a creation request for the media sharing room; 5. checking whether there is a live stream permission; 6. if not, returning a creation rejection notification; 7. if yes, returning a creation success notification; 8. checking whether a creator sets making a recommendation to a nearby person; 9. transmitting, by a server, a query request to a user (namely, a viewer end), to query whether the user is near the creator; 10. a user response, returning a result indicating whether the user is near the creator; 11. tapping, by the user, a “nearby room” button; and 12. recommending the media sharing room to the nearby user. Detailed descriptions are provided below.
(1) Create a room. FIG. 13 is a schematic diagram of the creation of a media sharing room according to an embodiment of this application. A creator opens a media sharing room recommendation interface (as shown in (1) in FIG. 13) on a client end, displays a media content selection interface in response to a room creation control “selecting content to create a room” on the media sharing room recommendation interface, selects media content (as shown in (2) in FIG. 13) to be played in the media sharing room through the media content selection interface, and enters a room setting interface. The room setting interface may be configured for the creator to set a privacy mode (including a friend mode and a public mode) of the media sharing room, a room name of the media sharing room, and the like, as shown in (3) in FIG. 13.
(2) Room setting. Whether the media sharing room is allowed to be recommended to a nearby person may be set. In this case, a real location of the creator needs to be accessed, and the real location needs to be transmitted to a server together with a creation request. The real location of the creator is transmitted to the server after the creator agrees. The real location of the creator is not private information for the server, but is private information for other users or malicious attackers. The objective of privacy protection in the embodiments of this application is to not snoop location privacy of a passive user. For example, when a to-be-recommended user recommends the media sharing room, a precise location of the to-be-recommended user cannot be obtained. When the creator needs to make a recommendation to a nearby person, it is equivalent to agreeing to actively provide location information of the creator, to use a function of making a recommendation to the nearby person of the server.
(3) Live stream starting setting. FIG. 14 is a live stream setting interface of a media sharing room according to an embodiment of this application. In this embodiment of this application, the media sharing room further supports a case in which the user (for example, the creator) with a live stream permission performs live streaming in the media sharing room. In a live stream setting process of the media sharing room, functions such as a camera use permission, a microphone use permission, live stream clarity, beauty, and makeup may be set.
(4) A client of the creator transmits a creation request for the media sharing room to the server. The server checks whether the creator has a live stream permission. If the creator does not have the live stream permission, creation of the media sharing room is not allowed. If the creator has the live stream permission, the media sharing room is created for a live stream host.
(5) If the creator sets a requirement to make a recommendation to a nearby person, the server transmits requests to all users who open the media sharing room recommendation interface, to query whether the user is near the creator. If the user is near the creator, the media sharing room is saved in a to-be-recommended list of the user, and the media sharing room is returned to the user when the user actively obtains the media sharing room. This operation is an asynchronous procedure between the server and the client, and is unaware to the user.
(6) The user actively taps a “nearby room” button, to actively pull a nearby media sharing room.
(7) The server may push the media sharing room to the user near the creator according to a priority and a product policy.

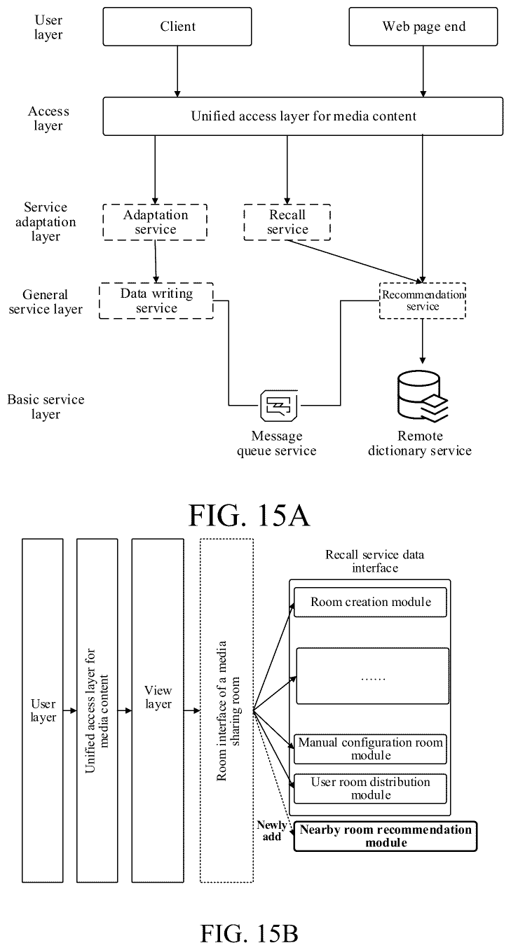

The following describes an overall architecture of a recommendation system of a media sharing room provided in the embodiments of this application. FIG. 15A is a schematic diagram of an architecture of a recommendation system of a media sharing room according to an embodiment of this application. The recommendation system of the media sharing room includes: (1) A user layer, including a client and a web page end that support the media sharing room. (2) An access layer, configured to access media content played in the media sharing room. (3) A service adaptation layer, including an adaptation service (room_adapter) and a recall (recall) service of the media sharing room. The recall service provides data for a media sharing room recommendation interface. Because to support a “nearby room” recommendation function, a “nearby room recommendation module” is newly added to the recall service, which is responsible for recommending the nearby media sharing room to a user. The user may obtain the nearby media sharing room on the media sharing room recommendation interface through the “nearby room recommendation module”. The “nearby room recommendation module” is provided by a recommendation service. FIG. 15B is a schematic diagram of an architecture of a recommendation system of a media sharing room according to an embodiment of this application. It may be learnt that the “nearby room recommendation module” is added to the media sharing room recommendation interface. (4) A general service layer, including a data writing service (room_write) and a recommendation service (namely, the foregoing server) of the media sharing room. (5) A basic service layer, including a message queue service (MQ) and a remote dictionary service (Redis).

The following continues to describe the method for recommending a media sharing room provided in the embodiments of this application. Referring to FIG. 14, a creator with a live stream starting permission may create a media sharing room of the creator. Live stream starting settings such as beauty and a filter may be made during room creation, and room basic information such as a room title and whether to make a recommendation to a nearby person may also be set. A server recommends the media sharing room to the nearby person when the creator sets a case of allowing to make a recommendation to the nearby person.

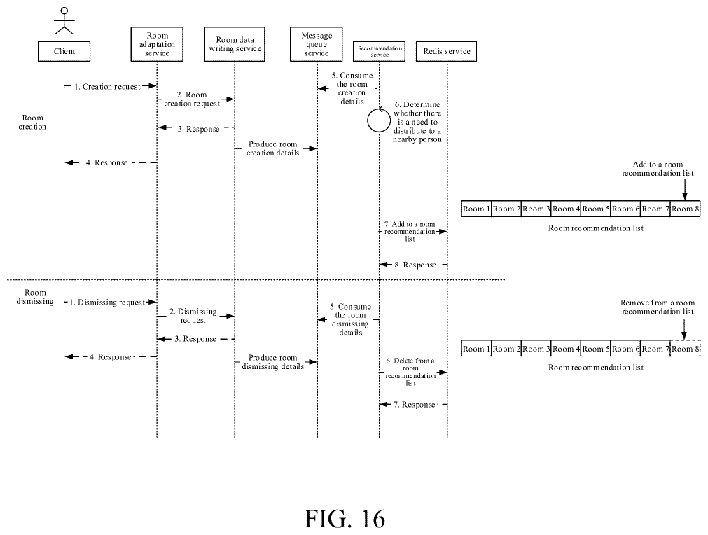

FIG. 16 is a schematic diagram of a creation procedure and a dismissing procedure of a media sharing room according to an embodiment of this application. A procedure of creating a media sharing room includes: 1. transmitting, by a creator, a request of creating the media sharing room to a room adaptation service through a client; 2. transmitting, by the room adaptation service, the creation request to a room data writing service; 3. returning, by the room data writing service, a response to the room adaptation service, producing a room creation details message, and transmitting the room creation details message to the message queue service; 4. returning, by the room adaptation service, a response to the client; 5. consuming, by a recommendation service, the room creation details message from the message queue service; 6. determining whether a media sharing room corresponding to the room creation details message needs to be recommended to a nearby person; 7. if yes, storing, by the recommendation service, the media sharing room in a redis service, to add the media sharing room to a room recommendation list; and 8. returning, by the redis service, a response to the recommendation service. A procedure of dismissing the media sharing room includes: 1. transmitting, by the client, a request of dismissing the media sharing room to the room adaptation service; 2. transmitting, by the room adaptation service, the dismissing request to the room data writing service; 3. returning, by the room data writing service, a response to the room adaptation service, producing a room dismissing details message, and transmitting the room dismissing details message to the message queue service; 4. returning, by the room adaptation service, a response to the client; 5. consuming, by the recommendation service, the room dismissing details message from the message queue service; 6. notifying, by the recommendation service, the redis service to delete the media sharing room from the room recommendation list; and 7. returning, by the redis service, a response to the recommendation service.

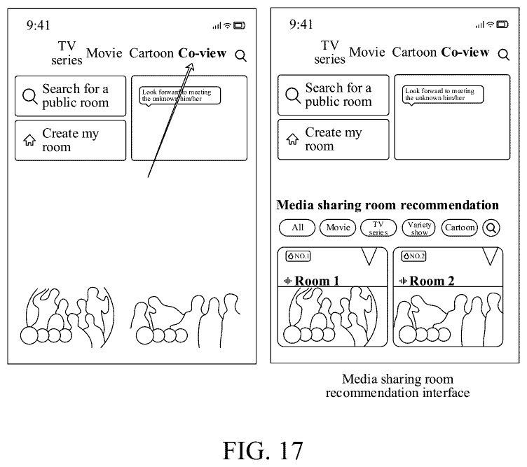

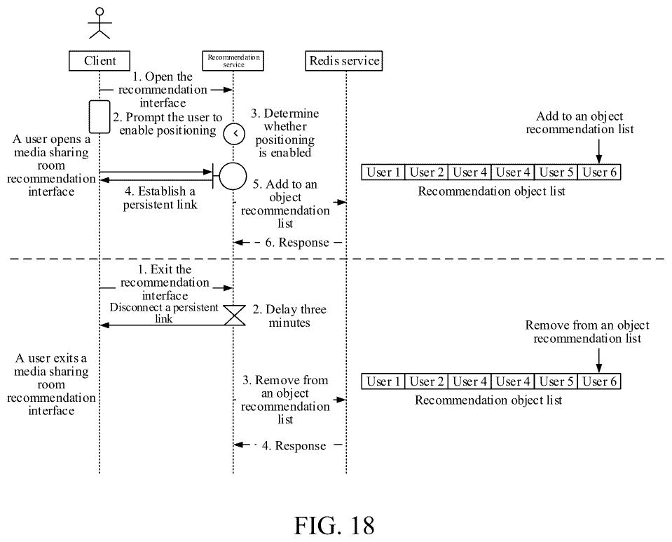

In one embodiment, FIG. 17 is a schematic diagram of an opening procedure of a media sharing room recommendation interface according to an embodiment of this application. When a server detects that a user opens the media sharing room recommendation interface (that is, triggers a trigger operation for a “co-viewing” control), the user becomes an object of a recommendation service. The server adds the user to a recommendation object list, and returns related information of the media sharing room recommendation interface to a terminal to enable the terminal to display the media sharing room recommendation interface. When detecting that the user exits the media sharing room recommendation interface, the server removes the user from the recommendation object list. FIG. 18 is a schematic diagram of a processing procedure when a media sharing room recommendation interface is opened and exited according to an embodiment of this application. (1) When a user opens the media sharing room recommendation interface, 1. the user opens the media sharing room recommendation interface on a client; 2. the client prompts the user to start positioning; 3. a recommendation service (namely, a server) determines whether the client starts positioning; 4. if yes, the recommendation service establishes a persistent communication connection to the client; 5. the recommendation service notifies a redis service to add the user to a recommendation object list; and 6. the redis service returns a response to the recommendation service. (2) When the user exits the media sharing room recommendation interface, 1. the user exits the media sharing room recommendation interface on the client; 2. when detecting that the user exits the media sharing room recommendation interface, the recommendation service disconnects the persistent communication connection to the client after a delay of three minutes; 3. the recommendation service notifies the redis service to remove the user from the recommendation object list; and 4. the redis service returns a response to the recommendation service.

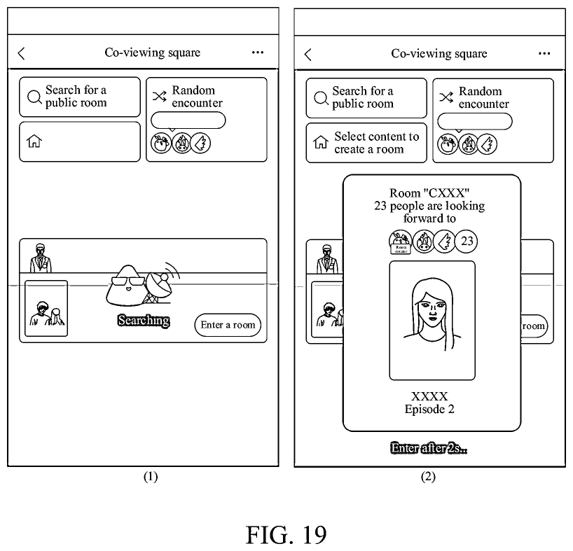

FIG. 19 is a schematic diagram of a recommendation display of a media sharing room according to an embodiment of this application. When a user taps a “nearby room” button, the user is required to start positioning and give a permission (where user positioning is only used by a client and is not obtained by a recommendation service) to recommend accessing location information. After the permission is given, the user may start searching for a nearby media sharing room (as shown in (1) in FIG. 19). When the media sharing room is found, room card information (as shown in (2) in FIG. 19) is displayed. In some embodiments, the media sharing room may be automatically entered by default after 2s, or the room may be actively entered by the user. Certainly, the user may further ignore the room card information to continue to search for a nearby media sharing room. If search duration exceeds a specific time period (for example, 20 seconds), it is prompted that there is no nearby media sharing room currently, and the user is prompted to try again later.

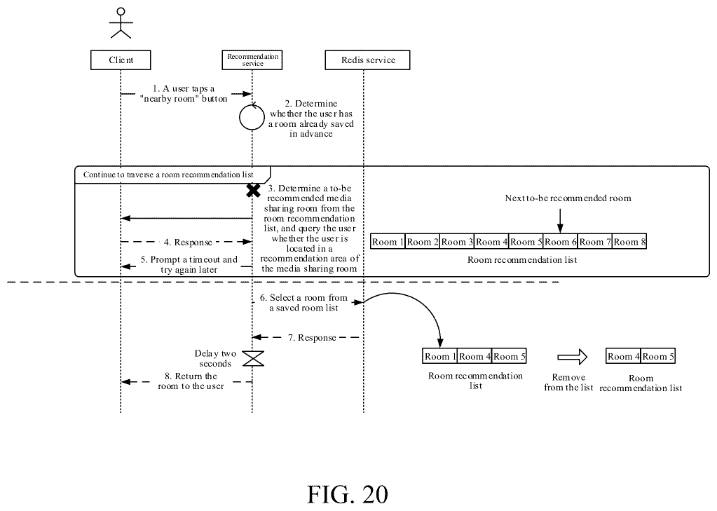

FIG. 20 is a schematic diagram of a recommendation procedure of a media sharing room according to an embodiment of this application. The procedure includes: 1. receiving, by a client, a trigger operation of a user on a “nearby room” button, and transmitting a request to join a media sharing room to a recommendation service; 2. determining, by the recommendation service, whether the user has a target media sharing room already saved in advance; 3. if the user does not have a target media sharing room already saved in advance, determining a to-be-recommended media sharing room from a room recommendation list, and querying the client whether the user is located in a recommended area of the media sharing room; 4. returning, by the client, a response, to notify the recommendation service whether the user is located in the recommended area of the media sharing room; 5. if the user is not located in the recommended area of the media sharing room and recommendation duration for the user reaches specific duration, prompting a timeout and trying again later; and if the user is located in the recommended area of the media sharing room, recommending the media sharing room to the user; 6. if the user has a target media sharing room already stored in advance, notifying a redis service to select one media sharing room from the pre-saved target media sharing room; 7. returning, by the redis service, the selected media sharing room to the recommendation service; and 8. recommending, by the recommendation service, the selected media sharing room to the client after a delay of 2 s.

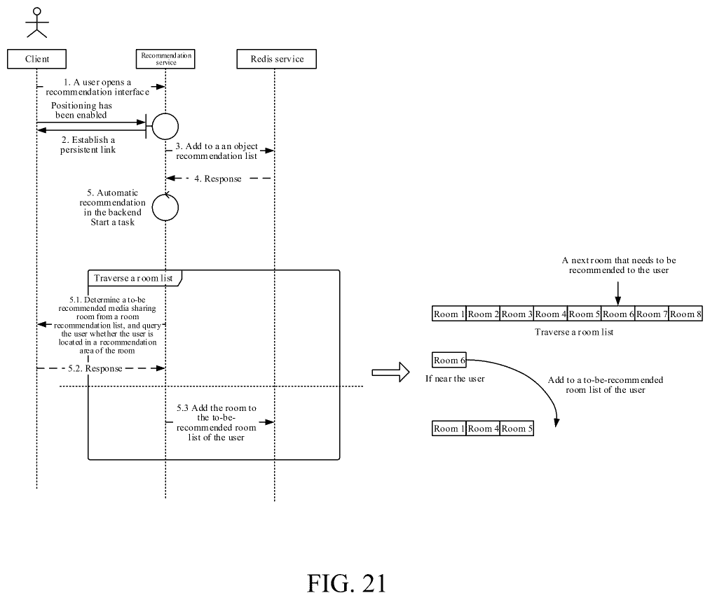

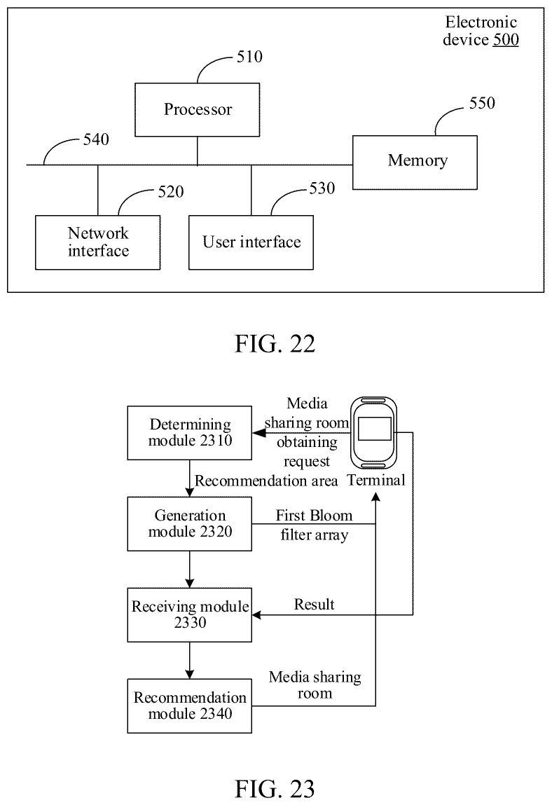

In one embodiment, once the user opens the media sharing room recommendation interface, asynchronous automatic recommendation of the recommendation service starts. For an asynchronous automatic recommendation procedure, refer to FIG. 21. FIG. 21 is a schematic diagram of a recommendation procedure of a media sharing room according to an embodiment of this application. The procedure includes: 1. opening, by a user, a media sharing room recommendation interface on a client; 2. after determining that positioning is enabled by the client, establishing, by a recommendation service, a persistent communication connection to the client; 3. notifying, by the recommendation service, a redis service to add the user to a recommendation object list; 4. returning, by the redis service, a response to the recommendation service; and 5. starting, by the recommendation service, an automatic recommendation task, including: 5.1. traversing a room recommendation list, and querying, for each media sharing room in the room recommendation list, the client whether the user is located in a recommended area of the media sharing room; 5.2. returning, by the client, a response, to notify the recommendation service whether the user is located in the recommended area of the media sharing room; and 5.3. if yes, adding the media sharing room to a to-be-recommended room list of the user, to recommend each media sharing room in the to-be-recommended room list to the user.

The foregoing embodiments of this application are applied. (1) A spatial Bloom filter and a homomorphic encryption technology are used in combination, to fully use advantages of the spatial Bloom filter and the homomorphic encryption technology, and provide a location service for the user while protecting location privacy of the user. (2) Landing is simple to implement, which plays a pushing role for research on protection of the location privacy of the user and development of landing. (3) A balance between good user experience and protection of user privacy is achieved.

The following describes an apparatus for recommending a media sharing room provided in the embodiments of this application. FIG. 24 is a schematic diagram of a structure of an apparatus for recommending a media sharing room according to an embodiment of this application. The apparatus for recommending a media sharing room provided in this embodiment of this application includes: a determining module 2310, configured to determine, in response to a request to join a media sharing room by a target object, a recommended area associated with a to-be-recommended media sharing room; a distance between the recommended area and a creator of the media sharing room being less than a distance threshold, and the media sharing room being configured for at least one viewer who joins the media sharing room to view media content played in the media sharing room; a generation module 2320, configured to generate a first Bloom filter array corresponding to a location of the recommended area, and transmit the first Bloom filter array to a terminal of the target object; a receiving module 2330, configured to receive, from the terminal, a result indicating whether the target object is located in the recommended area, the result being determined based on the first Bloom filter array and a second Bloom filter array, and the second Bloom filter array corresponding to a location of the target object; and a recommendation module 2340, configured to recommend the media sharing room to the terminal when the result indicates that the target object is located in the recommended area.

In some embodiments, the determining module 2310 is further configured to determine a plurality of candidate recommended areas obtained through pre-division; obtain first location information of the creator of the media sharing room, and obtain area location information of each candidate recommended area; determine a distance between the creator and each candidate recommended area based on the first location information and the area location information; and use the candidate recommended area corresponding to the distance less than the distance threshold as the recommended area associated with the media sharing room.

In some embodiments, the generation module 2320 is further configured to obtain an quantity of recommended areas, and construct an initial Bloom filter array based on the quantity of recommended areas; obtain at least one objective function configured for generating the first Bloom filter array; and map the location of the recommended area into the initial Bloom filter array based on the at least one objective function, to obtain the first Bloom filter array.

In some embodiments, the generation module 2320 is further configured to obtain a misjudgment score corresponding to the first Bloom filter array, where the misjudgment score indicates a possibility that the result determined based on the first Bloom filter array is a wrong result; determine an element quantity of elements included in the initial Bloom filter array based on the quantity of recommended areas and the misjudgment score; and construct an array including a quantity of elements as the initial Bloom filter array, the quantity of the elements being equal to the element quantity.

In some embodiments, the generation module 2320 is further configured to determine a function quantity of the objective function based on the quantity of recommended areas and the element quantity; and obtain a quantity of objective functions configured for generating the first Bloom filter array, the quantity of objective functions being equal to the function quantity.

In some embodiments, when the quantity of recommended areas of the recommended area is more than one, the generation module 2320 is further configured to obtain a recommendation priority of each recommended area, where the recommendation priority indicates a priority of recommending the media sharing room to an object located in the recommended area; and construct an initial Bloom filter array in a binary format based on the quantity of recommended areas when the recommendation priorities of the recommended area are the same, where each element in the initial Bloom filter array is 0; and correspondingly, the generation module 2320 is further configured to separately perform the following processing for each recommended area, to obtain the first Bloom filter array: determining a function value of each objective function based on the location of the recommended area, where the function value indicates an element location of the element into which the location of the recommended area is mapped in the initial Bloom filter array; setting, for each function value, the element in the initial Bloom filter array whose element location is the function value to 1.

In some embodiments, when the quantity of recommended is more than one, the generation module 2320 is further configured to obtain a recommendation priority of each recommended area, where the recommendation priority indicates a priority of recommending the media sharing room to an object located in the recommended area; and when different recommendation priorities exist and a quantity of different recommendation priorities is more than one, construct an initial Bloom filter array in an m-ary format, where each element in the initial Bloom filter array is 0, and m is an integer greater than the quantity of recommendation priorities; and correspondingly, the generation module 2320 is further configured to separately perform the following processing for each recommended area, to obtain the first Bloom filter array: determining a function value of each objective function based on the location of the recommended area, where the function value indicates an element location of the element into which the location of the recommended area is mapped in the initial Bloom filter array; obtaining a target value corresponding to the recommendation priority of the recommended area, where the target value is an integer greater than 0 and less than m, and the target value is positively correlated to the recommendation priority; and setting, for each function value, the element in the initial Bloom filter array whose element location is the function value to the target value.

In some embodiments, the result is represented by a product array obtained by multiplying the first Bloom filter array by the second Bloom filter array; and the receiving module 2330 is further configured to obtain a first quantity of non-0 elements in the product array and a second quantity of the objective function; when the first quantity is equal to the second quantity, determine that the result indicates that the target object is located in the recommended area; and when the first quantity is not equal to the second quantity, determine that the result indicates that the target object is not located in the recommended area.

In some embodiments, the receiving module 2330 is further configured to: when target locations in the first Bloom filter array are all non-0 elements, receive, from the terminal, a result indicating that the target object is located in the recommended area; and when not all target locations in the first Bloom filter array are non-0 elements, receive, from the terminal, a result indicating that the target object is not located in the recommended area, where the target locations are the same as locations at which non-0 elements in the second Bloom filter array are located.

In some embodiments, the result is represented by a product array obtained by multiplying the first Bloom filter array by the second Bloom filter array; and the recommendation module 2340 is further configured to obtain a first quantity of non-0 elements in the product array and a second quantity of the objective function; when the first quantity is equal to the second quantity, determine a minimum element value of the non-0 elements and a target recommendation priority corresponding to the minimum element value; determine that the target object is located in a target recommended area corresponding to the target recommendation priority; and correspondingly, a quantity of to-be-recommended objects of the media sharing room is more than one, the plurality of to-be-recommended objects include the target object, and the recommendation module 2340 is further configured to determine a first recommendation priority of a recommended area in which a first to-be-recommended object is located, where the first to-be-recommended object is a to-be-recommended object in the plurality of to-be-recommended objects other than the target object; and recommend the media sharing room to the terminal when the target recommendation priority is higher than the first recommendation priority.

In some embodiments, the generation module 2320 is further configured to perform homomorphic encryption processing on the first Bloom filter array, to obtain an encrypted Bloom filter array; and transmit the encrypted Bloom filter array to the terminal of the target object, where the encrypted Bloom filter array is configured for the terminal to multiply the second Bloom filter array by the encrypted Bloom filter array to obtain a product array, randomly shuffle element locations of elements in the product array to obtain an out-of-order product array, and return the out-of-order product array, where the out-of-order product array indicates the result indicating whether the target object is located in the recommended area; and correspondingly, the receiving module 2330 is further configured to receive the out-of-order product array returned by the terminal.

In some embodiments, the determining module 2310 is further configured to determine, in response to the request to join a media sharing room by the target object, whether the target object has an associated target media sharing room; and determine, when the target object does not have the associated target media sharing room, the recommended area associated with the to-be-recommended media sharing room.

In some embodiments, the determining module 2310 is further configured to: before the determining, in response to a request to join a media sharing room by a target object, a recommended area associated with a to-be-recommended media sharing room, establish a persistent communication connection to the terminal when detecting that the target object triggers an opening operation on a media sharing room recommendation interface, and add the target object to a to-be-recommended object list of the media sharing room; and correspondingly, the determining module 2310 is further configured to disconnect the persistent communication connection to the terminal after target duration when detecting that the target object triggers an exit operation on the media sharing room recommendation interface.

In some embodiments, the recommendation module 2340 is further configured to transmit prompt information to the terminal when a target quantity of target Bloom filter arrays have been transmitted to the target object, and a result indicating that the target object is not located in a corresponding recommended area is received by each target Bloom filter array, where the target Bloom filter array corresponds to a target media sharing room, and the prompt information is configured for prompting the target object to re-transmit the obtaining request after target duration.

Through application of the foregoing embodiments of this application, after receiving a request to join a media sharing room from the target object, the recommended area associated with the to-be-recommended media sharing room is determined, the first Bloom filter array corresponding to the location of the recommended area is generated, and the first Bloom filter array is transmitted to the terminal of the target object, so that the terminal of the target object determines, based on the first Bloom filter array and the second Bloom filter array, the result indicating whether the target object is located in the recommended area, and returns the result. When the result indicating that the target object is located in the recommended area is received, the media sharing room is recommended to the terminal.

The distance between the recommended area and the creator of the media sharing room is less than the distance threshold. When whether the target object is located in the recommended area is determined, the first Bloom filter array corresponding to the location of the recommended area is transmitted to the terminal of the target object; and the result indicating whether the target object is located in the recommended area is returned by the terminal of the target object. Accordingly, in a process of recommending the media sharing room, the target object does not need to provide a real location of the target object to another party, and a real location of the recommended area whose distance from the creator is lower than the distance threshold also does not need to be provided to the target object. This ensures that location privacy of two parties is not disclosed, and improves security of the location privacy when a media sharing room recommendation is made based on a location.

The following describes an electronic device that implements the method for recommending a media sharing room provided in the embodiments of this application. FIG. 23 is a schematic diagram of a structure of an electronic device 500 for implementing a method for recommending a media sharing room according to an embodiment of this application. The electronic device 500 may be a server or a terminal. An example in which the electronic device 500 is the server shown in FIG. 1 is used. That the electronic device 500 implements the method for recommending a media sharing room provided in the embodiments of this application includes at least one processor 510, a memory 550, at least one network interface 520, and a user interface 530. All the components in the electronic device 500 are coupled together by using a bus system 540. The bus system 540 is configured to implement connection and communication between the components. In addition to a data bus, the bus system 540 further includes a power bus, a control bus, and a status signal bus. However, for ease of clear description, all types of buses in FIG. 23 are marked as the bus system 540.

The processor 510 may be an integrated circuit chip having a signal processing capability, for example, a general purpose processor, a digital signal processor (DSP), or another programmable logic device (PLD), discrete gate, transistor logical device, or discrete hardware component. The general purpose processor may be a microprocessor, any conventional processor, or the like.

The memory 550 may be a removable memory, a non-removable memory, or a combination thereof. In an embodiment, the memory 550 includes one or more storage devices physically away from the processor 510. The memory 550 includes a volatile memory or a non-volatile memory, or may include both the volatile memory and the non-volatile memory. The non-volatile memory may be a read-only memory (ROM), and the volatile memory may be a random access memory (RAM). The memory 550 described in the embodiments of this application is to include any other suitable type of memory.

The memory 550 can store data to support various operations, and examples of the data include programs, modules, and data structures, or subsets or supersets thereof. In the embodiment of this application, the memory 550 stores computer-executable instructions. When the computer-executable instructions are executed by the processor 510, the processor 510 is enabled to perform the method for recommending a media sharing room provided in the embodiments of this application.

The embodiments of this application further provide a computer program product. The computer program product includes computer-executable instructions. The computer-executable instructions are stored in a computer-readable storage medium. A processor of an electronic device reads the computer-executable instructions from the computer-readable storage medium, and the processor executes the computer-executable instructions, to enable the electronic device to perform the method for recommending a media sharing room provided in the embodiments of this application.

Embodiments of this application further provide a computer-readable storage medium, having computer-executable instructions stored therein. When the computer-executable instructions are executed by a processor, the processor is enabled to perform the method for recommending a media sharing room provided in the embodiments of this application.

In some embodiments, the computer-readable storage medium may be a memory such as an FRAM, a ROM, a PROM, an EPROM, an EEPROM, a flash memory, a magnetic surface memory, a compact disc, or a CD-ROM; or may be various devices including one of or any combination of the foregoing memories.

In some embodiments, the computer-executable instructions may be written in the form of a program, software, a software module, a script, or code and according to a programming language (including a compiler or interpreter language or a declarative or procedural language) in any form, and may be deployed in any form, including an independent program or a module, a component, a subroutine, or another unit suitable for use in a computing environment.

In an example, the computer-executable instructions may, but do not necessarily, correspond to a file in a file system, and may be stored in a part of a file that saves another program or other data, for example, be stored in one or more scripts in a hyper text markup language (HTML) file, stored in a file that is specially used for a program in discussion, or stored in a plurality of collaborative files (for example, be stored in files of one or more modules, subprograms, or code parts).

As an example, the computer-executable instructions may be deployed on one electronic device for execution, or executed on a plurality of electronic devices located at one location, or executed on a plurality of electronic devices distributed at a plurality of locations and interconnected by using a communications network.

The foregoing descriptions are merely embodiments of this application and are not intended to limit the protection scope of this application. Any modification, equivalent replacement, or improvement made without departing from the spirit and range of this application shall fall within the protection scope of this application.

What is claimed is:

1. A method for recommending a media sharing room, performed by an electronic device, the method comprising:
determining, in response to a request to join a media sharing room by a target object, a recommended area associated with a to-be-recommended media sharing room, a distance between the recommended area and a creator of the media sharing room being less than a distance threshold, and the media sharing room being configured for at least one viewer who joins the media sharing room to view media content played in the media sharing room;
generating a first Bloom filter array corresponding to a location of the recommended area, and transmitting the first Bloom filter array to a terminal of the target object;
receiving, from the terminal, a result indicating whether the target object is located in the recommended area, the result being determined based on the first Bloom filter array and a second Bloom filter array, and the second Bloom filter array corresponding to a location of the target object; and
recommending the media sharing room to the terminal when the result indicates that the target object is located in the recommended area.

2. The method according to claim 1, wherein the determining a recommended area associated with a to-be-recommended media sharing room comprises:
determining a plurality of candidate recommended areas obtained through pre-division;
obtaining first location information of the creator of the media sharing room, and obtaining area location information of each candidate recommended area;
determining a distance between the creator and each candidate recommended area based on the first location information and the area location information; and
identifying the candidate recommended area corresponding to the distance less than the distance threshold as the recommended area associated with the media sharing room.

3. The method according to claim 1, wherein the generating a first Bloom filter array corresponding to a location of the recommended area comprises:
obtaining a quantity of recommended areas, and constructing an initial Bloom filter array based on the quantity of the areas;
obtaining at least one objective function configured for generating the first Bloom filter array; and
mapping the location of the recommended area into the initial Bloom filter array based on the at least one objective function, to obtain the first Bloom filter array.

4. The method according to claim 3, wherein the constructing an initial Bloom filter array based on the quantity of recommended areas comprises:
obtaining a misjudgment score corresponding to the first Bloom filter array, wherein the misjudgment score indicates a possibility that the result determined based on the first Bloom filter array is a wrong result;
determining an element quantity of elements comprised in the initial Bloom filter array based on the quantity of recommended areas and the misjudgment score; and
constructing an array comprising a quantity of elements as the initial Bloom filter array, the quantity of the elements being equal to the element quantity.

5. The method according to claim 4, wherein the obtaining at least one objective function configured for generating the first Bloom filter array comprises:
determining a function quantity of the objective function based on the quantity of recommended areas and the element quantity; and
obtaining a quantity of objective functions configured for generating the first Bloom filter array, the quantity of objective functions being equal to the function quantity.

6. The method according to claim 3, wherein when the quantity of recommended is more than one, the constructing an initial Bloom filter array based on the quantity of recommended areas comprises:
obtaining a recommendation priority of each recommended area, wherein the recommendation priority indicates a priority of recommending the media sharing room to an object located in the recommended area; and
constructing an initial Bloom filter array in a binary format based on the quantity of recommended areas when the recommendation priorities of the recommended area are the same, wherein each element in the initial Bloom filter array is 0; and
the mapping the location of the recommended area into the initial Bloom filter array based on the at least one objective function, to obtain the first Bloom filter array comprises:
separately performing the following processing for each recommended area, to obtain the first Bloom filter array;
determining a function value of each objective function based on the location of the recommended area, wherein the function value indicates an element location of the element into which the location of the recommended area is mapped in the initial Bloom filter array; and
setting, for each function value, the element in the initial Bloom filter array whose element location is the function value to 1.

7. The method according to claim 3, wherein when the quantity of recommended areas of the recommended area is more than one, the constructing an initial Bloom filter array based on the recommended quantity of recommended areas comprises:
obtaining a recommendation priority of each recommended area, wherein the recommendation priority indicates a priority of recommending the media sharing room to an object located in the recommended area; and
when different recommendation priorities exist and a quantity of different recommendation priorities is more than one, constructing an initial Bloom filter array in an m-ary format, wherein each element in the initial Bloom filter array is 0, and m is an integer greater than the quantity of recommendation priorities; and
the mapping the location of the recommended area into the initial Bloom filter array based on the at least one objective function, to obtain the first Bloom filter array comprises separately performing the following processing for each recommended area, to obtain the first Bloom filter array;
determining a function value of each objective function based on the location of the recommended area, wherein the function value indicates an element location of the element into which the location of the recommended area is mapped in the initial Bloom filter array;
obtaining a target value corresponding to the recommendation priority of the recommended area, wherein the target value is an integer greater than 0 and less than m, and the target value is positively correlated to the recommendation priority; and
setting, for each function value, the element in the initial Bloom filter array whose element location is the function value to the target value.

8. The method according to claim 6, wherein the result is represented by a product array obtained by multiplying the first Bloom filter array by the second Bloom filter array; and
after the receiving, from the terminal, a result indicating whether the target object is located in the recommended area, the method further comprises:
obtaining a first quantity of non-0 elements in the product array and a second quantity of the objective function;
when the first quantity is equal to the second quantity, determining that the result indicates that the target object is located in the recommended area; and
when the first quantity is not equal to the second quantity, determining that the result indicates that the target object is not located in the recommended area.

9. The method according to claim 6, wherein the receiving, from the terminal, a result indicating whether the target object is located in the recommended area comprises:
when target locations in the first Bloom filter array are all non-0 elements, receiving, from the terminal, a result indicating that the target object is located in the recommended area; and
when not all target locations in the first Bloom filter array are non-0 elements, receiving, from the terminal, a result indicating that the target object is not located in the recommended area, wherein the target locations are the same as locations at which non-0 elements in the second Bloom filter array are located.

10. The method according to claim 7, wherein the result is represented by a product array obtained by multiplying the first Bloom filter array by the second Bloom filter array;
after the receiving, from the terminal, a result indicating whether the target object is located in the recommended area, the method further comprises:
obtaining a first quantity of non-0 elements in the product array and a second quantity of the objective function;
when the first quantity is equal to the second quantity, determining a minimum element value of the non-0 elements and a target recommendation priority corresponding to the minimum element value;
determining that the target object is located in a target recommended area corresponding to the target recommendation priority; and
a quantity of to-be-recommended objects of the media sharing room is more than one, the plurality of to-be-recommended objects comprise the target object, and the recommending the media sharing room to the terminal comprises:
determining a first recommendation priority of a recommended area in which a first to-be-recommended object is located, wherein the first to-be-recommended object is a to-be-recommended object in the plurality of to-be-recommended objects other than the target object; and
recommending the media sharing room to the terminal when the target recommendation priority is higher than the first recommendation priority.

11. The method according to claim 1, wherein the transmitting the first Bloom filter array to a terminal of the target object comprises:
performing homomorphic encryption processing on the first Bloom filter array, to obtain an encrypted Bloom filter array; and
transmitting the encrypted Bloom filter array to the terminal of the target object, wherein
the encrypted Bloom filter array is configured for the terminal to multiply the second Bloom filter array by the encrypted Bloom filter array to obtain a product array, randomly shuffle element locations of elements in the product array to obtain an out-of-order product array, and return the out-of-order product array, wherein
the out-of-order product array indicates the result indicating whether the target object is located in the recommended area; and
the receiving, from the terminal, a result indicating whether the target object is located in the recommended area comprises receiving the out-of-order product array returned by the terminal.

12. The method according to claim 1, wherein the determining, in response to a request to join a media sharing room by a target object, a recommended area associated with a to-be-recommended media sharing room comprises:
determining, in response to the request to join a media sharing room by the target object, whether the target object has an associated target media sharing room; and
determining, when the target object does not have the associated target media sharing room, the recommended area associated with the to-be-recommended media sharing room.

13. The method according to claim 1, wherein before the determining, in response to a request to join a media sharing room by a target object, a recommended area associated with a to-be-recommended media sharing room, the method further comprises:
establishing a persistent communication connection to the terminal when detecting that the target object triggers an opening operation on a media sharing room recommendation interface, and
adding the target object to a to-be-recommended object list of the media sharing room; and
the method further comprises:
disconnecting the persistent communication connection to the terminal after target duration when detecting that the target object triggers an exit operation on the media sharing room recommendation interface.

14. The method according to claim 1, wherein the method further comprises:
transmitting prompt information to the terminal when a target quantity of target Bloom filter arrays have been transmitted to the target object, and a result indicating that the target object is not located in a corresponding recommended area is received by each target Bloom filter array, wherein
the target Bloom filter array corresponds to a target media sharing room, and the prompt information is configured for prompting the target object to re-transmit the obtaining request after target duration.

15. An electronic device, comprising:
a memory, configured to store computer-executable instructions; and
a processor, configured to implement, when executing the computer-executable instructions stored in the memory, a method for recommending a media sharing room, comprising:
determining, in response to a request to join a media sharing room by a target object, a recommended area associated with a to-be-recommended media sharing room, a distance between the recommended area and a creator of the media sharing room being less than a distance threshold, and the media sharing room being configured for at least one viewer who joins the media sharing room to view media content played in the media sharing room;
generating a first Bloom filter array corresponding to a location of the recommended area, and transmitting the first Bloom filter array to a terminal of the target object;
receiving, from the terminal, a result indicating whether the target object is located in the recommended area, the result being determined based on the first Bloom filter array and a second Bloom filter array, and the second Bloom filter array corresponding to a location of the target object; and
recommending the media sharing room to the terminal when the result indicates that the target object is located in the recommended area.

16. The electronic device according to claim 15, wherein the determining a recommended area associated with a to-be-recommended media sharing room comprises:
determining a plurality of candidate recommended areas obtained through pre-division;
obtaining first location information of the creator of the media sharing room, and obtaining area location information of each candidate recommended area;
determining a distance between the creator and each candidate recommended area based on the first location information and the area location information; and
identifying the candidate recommended area corresponding to the distance less than the distance threshold as the recommended area associated with the media sharing room.

17. The electronic device according to claim 15, wherein the generating a first Bloom filter array corresponding to a location of the recommended area comprises:
obtaining a quantity of recommended areas, and constructing an initial Bloom filter array based on the quantity of the areas;
obtaining at least one objective function configured for generating the first Bloom filter array; and
mapping the location of the recommended area into the initial Bloom filter array based on the at least one objective function, to obtain the first Bloom filter array.

18. A non-transitory computer-readable storage medium, having computer-executable instructions stored therein, the computer-executable instructions, when executed by a processor, implementing a method for recommending a media sharing room, comprising:
determining, in response to a request to join a media sharing room by a target object, a recommended area associated with a to-be-recommended media sharing room, a distance between the recommended area and a creator of the media sharing room being less than a distance threshold, and the media sharing room being configured for at least one viewer who joins the media sharing room to view media content played in the media sharing room;
generating a first Bloom filter array corresponding to a location of the recommended area, and transmitting the first Bloom filter array to a terminal of the target object;
receiving, from the terminal, a result indicating whether the target object is located in the recommended area, the result being determined based on the first Bloom filter array and a second Bloom filter array, and the second Bloom filter array corresponding to a location of the target object; and
recommending the media sharing room to the terminal when the result indicates that the target object is located in the recommended area.

19. The computer-readable storage medium according to claim 18, wherein the determining a recommended area associated with a to-be-recommended media sharing room comprises:
determining a plurality of candidate recommended areas obtained through pre-division;
obtaining first location information of the creator of the media sharing room, and obtaining area location information of each candidate recommended area;
determining a distance between the creator and each candidate recommended area based on the first location information and the area location information; and
identifying the candidate recommended area corresponding to the distance less than the distance threshold as the recommended area associated with the media sharing room.

20. The computer-readable storage medium according to claim 18, wherein the generating a first Bloom filter array corresponding to a location of the recommended area comprises:
obtaining a quantity of recommended areas, and constructing an initial Bloom filter array based on the quantity of the areas;
obtaining at least one objective function configured for generating the first Bloom filter array; and
mapping the location of the recommended area into the initial Bloom filter array based on the at least one objective function, to obtain the first Bloom filter array.
